(19) United States
(12) Patent Application Publication
(10) Pub. No.: US 2025/0097511 A1
(43) Pub. Date: Mar. 20, 2025

(54) MULTIMEDIA-AWARE CONNECTED TV HOME-SCREEN TILES TO AID CONTENT DISCOVERY

(71) Applicant: Adeia Guides Inc., San Jose, CA (US)

(72) Inventors: Dhananjay Lal, Englewood, CO (US); Reda Harb, Tampa, FL (US); Tao Chen, Palo Alto, CA (US); Jean-Yves Couleaud, Mission Viejo, CA (US)

(21) Appl. No.: 18/368,432

(22) Filed: Sep. 14, 2023

(51) Int. Cl. H04N 21/431; H04N 21/258; H04N 21/482

(52) U.S. Cl. CPC H04N 21/4312; H04N 21/25808; H04N 21/25866; H04N 21/4826

(57) ABSTRACT

Systems and methods for displaying content within an icon/tile associated with an executable streaming media application without launching the associated executable streaming media application are disclosed. The methods display a plurality of icons relating to streaming media applications on a home screen of a user interface. An automatic selection of one or more icons is made based on a selection criterion. Upon determining a trigger, content referenced in a manifest file is accessed and displayed within the boundaries of the selected icon. The content is selected based one or more factors. The content displayed is deep-linked to a media asset associated with the content. The manifest file is updated, and a personalized manifest file based on user consumption history and display device parameters is received. The content from the updated manifest file is played within the icon.

### FIELD OF INVENTION

Embodiments of the present disclosure relate to displaying or playing media content (such as video or audio) within an icon displayed on a home screen of a user interface displayed on a display device (such as a television, laptop, or mobile phone) without launching the underlying executable streaming video or streaming audio application associated with the icon.

### BACKGROUND

Various types of user interfaces are used in the streaming media and streaming audio environment. For example, a smart television may have a user interface with a plurality of icons that are linked to a plurality of streaming video providers such as Netflix™, Hulu™, or Amazon Prime or Prime Video™, Sling™, Pandora™, ESPN™, or Disney™. The user interfaces may also display icons for platforms that provide videos, such as YouTube™ or TikTok™. They may also display icons related to social media, such as Facebook™, Snapchat™ or Instagram™ icons.

The user interfaces may differ from one manufacturer to another. For example, a user interface for Samsung TV may be different from the user interface for LG TV. Likewise, user interfaces that are displayed on the TV when a dongle or streaming stick is used, such as a Roku dongle or Amazon Prime dongle, may also differ from one another. Some may provide icons that are related to streaming video and audio providers as well as other sections, such as a sponsored section where content is displayed or sections where date, time, calendar, emails, and other information that may be useful to the user of the user interface is displayed.

While the style of the user interface differs, the icons displayed to the user that are related to streaming video and audio providers are static icons that, in many instances, display a still image of the service provider's logo or another type of still image. When a user selects the icon, the system automatically launches the underlying application that is-associated with the icon. For example, if a user selects the Netflix icon, which has a still image of Netflix logo, then the system may launch the Netflix application (App).

A problem with the existing home screen user interfaces of Smart TVs and streaming stick operating systems and their current use of an icon is that the icons represent still images and do not provide any additional appeal to the user for selecting one icon over another icon. This may occur because the Smart TV operating systems may not have information about the content available within an app. In limited scenarios, such as a Samsung TV, the content provider app may provide additional still thumbnails and text information about its popular or featured content to the Smart TV OS. This may become visible if a user hovers on the app icon.

Another problem with the existing user interfaces and their use of an icon is that the still images used in the icons become mundane or do not provide any additional benefit to the user aside from allowing the user to select the icon to launch the application.

Thus, there is a need for better systems and methods for better usage of the icons and the space occupied by the icons on the home screen of the user interface that would appeal to the user.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process for displaying or playing media content within an icon associated with an executable application and displayed on a home screen of a user interface, in accordance with some embodiments of the disclosure;

FIG. 2 is a block diagram of a system for displaying or playing media content within an icon associated with an executable application and displayed on a home screen of a user interface, in accordance with some embodiments of the disclosure;

FIG. 3 is a block diagram of a display device for displaying or playing media content within an icon associated with an executable application and displayed on a home screen of a user interface, in accordance with some embodiments of the disclosure;

FIG. 4 is a block diagram of a system having a video player imbedded within an icon/tile for playing a video or audio file within the icon/tile, in accordance with some embodiments of the disclosure;

FIG. 5 is a flowchart of a process for displaying or playing media content within an icon associated with an executable application and displayed on a home screen of a user interface, in accordance with some embodiments of the disclosure;

FIG. 6 is a flowchart of a process for displaying or playing media content within an icon associated with an executable application and displayed on a home screen of a user interface, in accordance with some embodiments of the disclosure;

FIG. 7A is a block diagram of a home screen of a user interface prior to executing an active media tile(s), in accordance with some embodiments of the disclosure;

FIG. 7B is a block diagram of a home screen of a user interface with active media tile(s) being displayed, in accordance with some embodiments of the disclosure;

FIG. 7C is a block diagram of a home screen of a user interface via an XR device, in accordance with some embodiments of the disclosure;

FIG. 8 is a block diagram of examples of icon selection options that may be utilized to display an active media tile, in accordance with some embodiments of the disclosure;

FIG. 9 is a flowchart of a process for selecting one or more winners from multiple bids received from service providers, in accordance with some embodiments of the disclosure;

FIG. 10 is a block diagram of examples of content types that can be selected for displaying in an active media tile, in accordance with some embodiments of the disclosure;

FIG. 11 is a block diagram of examples of display format options that may be used to display or play media content in an active media tile, in accordance with some embodiments of the disclosure;

FIG. 12 is a block diagram of processing options that may be used by a service provider when providing a manifest file for display, in accordance with some embodiments of the disclosure;

FIG. 13 is a block diagram of editorial policies for reserving high bitrate videos, in accordance with some embodiments of the disclosure;

FIG. 14 is a block diagram of icon/tile activation or triggers used to display content within an icon, in accordance with some embodiments of the disclosure;

FIG. 15 is a flowchart of a process for updating content for displaying in an icon, in accordance with some embodiments of the disclosure;

FIG. 16 is a block diagram of duration of display options for displaying content within an icon, in accordance with some embodiments of the disclosure;

FIG. 17 is a block diagram of a video montage containing videos from different media assets, in accordance with some embodiments of the disclosure;

FIG. 18 is a block diagram of deep links for different media assets of a video montage, in accordance with some embodiments of the disclosure; and

FIG. 19 is a flowchart of a communication process between a plurality of devices for displaying or playing media content within an icon associated with an executable application, in accordance with some embodiments of the disclosure.

### DETAILED DESCRIPTION

In accordance with some embodiments disclosed herein, some of the above-mentioned limitations are overcome by displaying content, such as a video, and/or playing audio with or without a video, within an icon associated with a streaming video or audio service provider, such as Netflix, Pandora, YouTube, etc., without launching the underlying application.

Accordingly, the embodiments disclosed herein, display a plurality of icons, each one associated with a service provider, on a home screen of a content aggregator user interface of a media device, also referred to herein as display device. The media device's operating system (OS), such as a Connected TV OS, is able to match content from service providers to corresponding applications that are associated with the icons displayed on the home screen. Accordingly, the OS of the media device is aware of which applications are installed on the home screen of the content aggregator user interface and keeps an index of such list.

The icons described are associated with executable streaming media applications, also referred to herein as OTT applications. These executable applications, such as Netflix, are connected to their associated service providers and used for accessing content from the service provider, such as streaming video or audio service provider. The methods select, without user intervention, an icon of at least one executable application, from the plurality of displayed icons. The selection is based on one or more criterion, such as bidding. Once an icon is selected using the criterion, upon a trigger mechanism being activated, content, such as a video clip (or an audio clip), also referred to as content item, is played within a boundary of the selected icon. The selection of the video clip or audio clip is based on a selection factor or criteria. The selection factor or criteria may be trending content or may be based on user profile, AI recommendation, user consumption history, etc. Activation of the trigger mechanism may include a user hovering over the icon using a controller, gazing at the user interface. The trigger mechanism may also be just the launching of the home page. Once the trigger is activated, the video or audio may be automatically played within the boundary of the selected icon without launching the executable application associated with the selected icon. In some embodiments, the icon may be enlarged when hovered upon, such as based on navigation of a cursor, navigation of a remote control on the home screen, navigation of a computer mouse, touch screen navigation, etc. In such scenarios the video may automatically be played within the boundary of the enlarged icon without launching the executable application. In yet other embodiments, the video may be automatically played when the icon is on the home screen of the content aggregator user interface that the user is viewing.

In some embodiments, the service provider that is associated with the executable OTT application, such as Netflix, may already be aware of the user's consumption history. Since the user may access Netflix for consuming content, Netflix may keep track of all content accessed and consumed, including specific details such as likes and dislikes of the user and types of genres preferred. Based on user such consumption history, and any user profile that may be generated at the service provider, the service provider may transmit a customized and personalized manifest file that is based on data gathered from such consumption history.

In other embodiments, where the user consumes content on another application or on TV, the methods may share data with the service providers to obtain customized and personalized manifest files that include the content that is to be played within the icon. The methods may continuously, or at periodic intervals, provide updates to the service providers and request updated manifest files. For example, when a user consumes a movie on a different application than the application associated with the service provider, or on TV, such data may be shared with the service provider to obtain a manifest file that is personalized based on the genre of the movie the user recently consumed. For example, content consumed on an Amazon App may be shared with Netflix. If not the details of the content, due to any sharing policies or restrictions of Amazon, then more generically the genre of the content consumed. Such methods, and others described herein, may be used to keep content fresh such that the user is engaged with the display within the icon and is enticed to select the icon for launching the underlying application.

The embodiment includes activating, removing, and deactivating video players that are associated with each icon. Since each icon may include a video player associated with it for playing content within the icon, it may be activated when content is to be played within the icon and deactivated if not being used to conserve computing resources. A separate video player for each icon may be instantiated by the operating system of the media device when a determination is made that content is to be played in that icon. For example, a Hulu video player may be instantiated to play content within a Hulu icon. The video player may also be enlarged in instances when the associated icon is enlarged. The resolution of the video player may be the same resolution of the icon and it may be scaled to make it bigger for displaying a larger display of the content played in the icon. The video player may replace a static icon, expand the static image in the icon, or be overlayed on the icon.

The embodiments may also include rearranging icons within the user interface based on their usage. For example, a certain icon may be moved to the front of a queue of icons. The icon may also be displayed more prominently, such as they may be enlarged or highlighted to grab the user's attention. The icons may also be removed from the user interface or enhanced, such as enlarged or moved to a spotlight or showcased in a different manner. In such a scenario, same action may also be applied to the associated video player, e.g., removed, enlarged, moved to another location where the icon is moved.

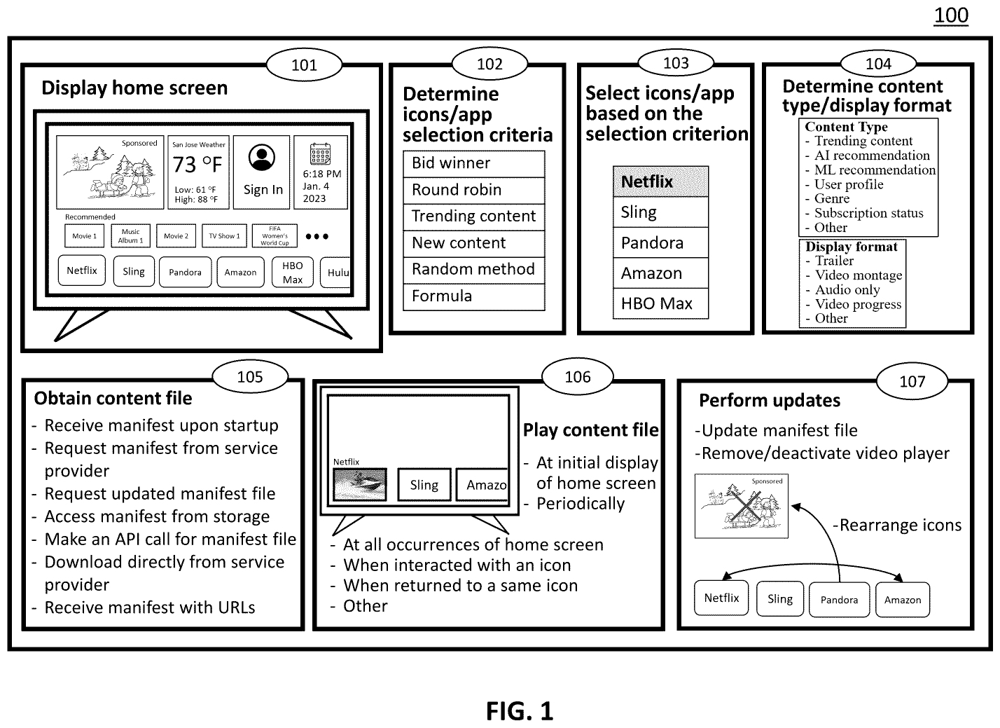

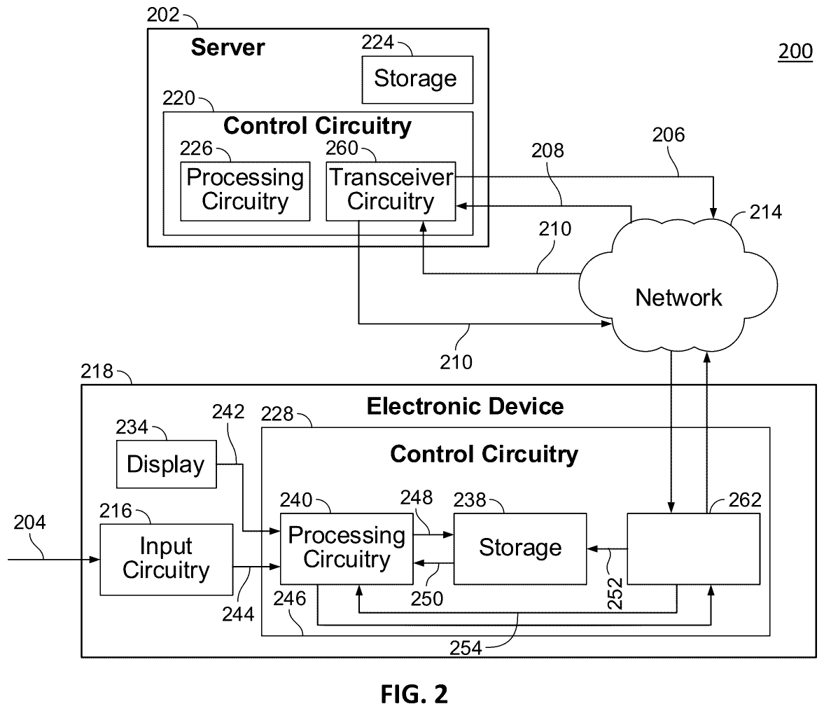

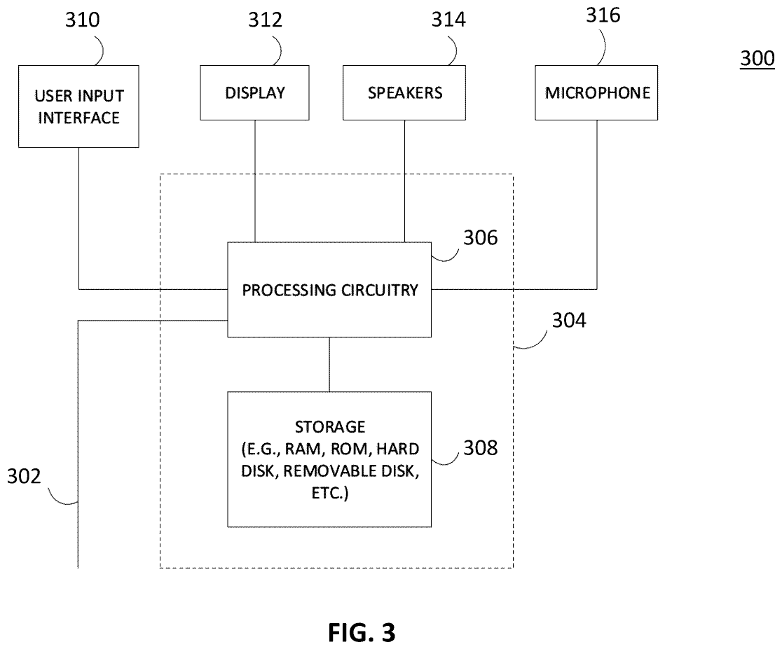

Turning to the figures, FIG. 1 is a block diagram of a process for displaying or playing media content within an icon associated with an executable streaming media/OTT application and displayed on a home screen of a user interface, in accordance with some embodiments of the disclosure. The process 100 may be implemented, in whole or in part, by systems or devices such as those shown in FIGS. 2-4. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

In some embodiments, at block 101, a home screen of a content aggregator is displayed on a home screen of a user interface of a display device. The display device, also referred to as media device, may be a smart television that includes a user interface that can display a home screen of a content aggregator. Other display devices that can also display a home screen of a content aggregator are contemplated within the embodiments.

The display device may include a user interface, such as a user interface of a content aggregator, that displays a plurality of executable applications. These applications may be associated with a streaming video and audio service provider, such as Netflix™, Hulu™, or Amazon Prime or Prime Video™, Sling™, Pandora™, ESPN™, or Disney™.

The user interface may include a plurality of screens and a home screen. The home screen may be the screen in which all icons or tiles of the executable applications provided by the user interface are displayed. In other words, the home screen of the user interface may be the topmost layer of the user interface, which is often the screen displayed when the user interface, such as the user interface of a content aggregator, is launched.

In one example, a Samsung television may have a user interface that is displayed when the television is first turned on. The user interface may display a plurality of icons associated with executable applications and may also display other areas with different types of content. For example, the other areas may include a display of the weather, the current date and time, and/or a selection of recommended movies for a particular user.

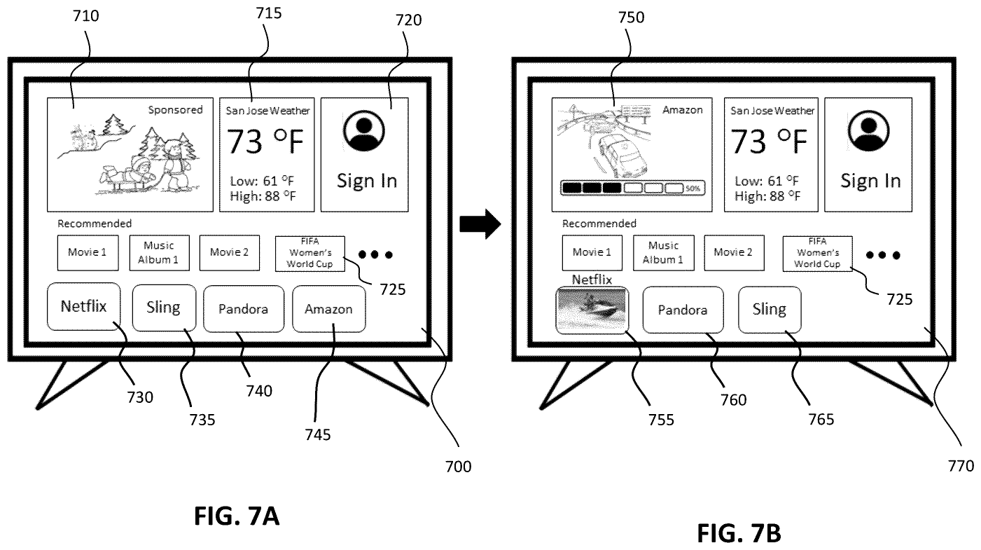

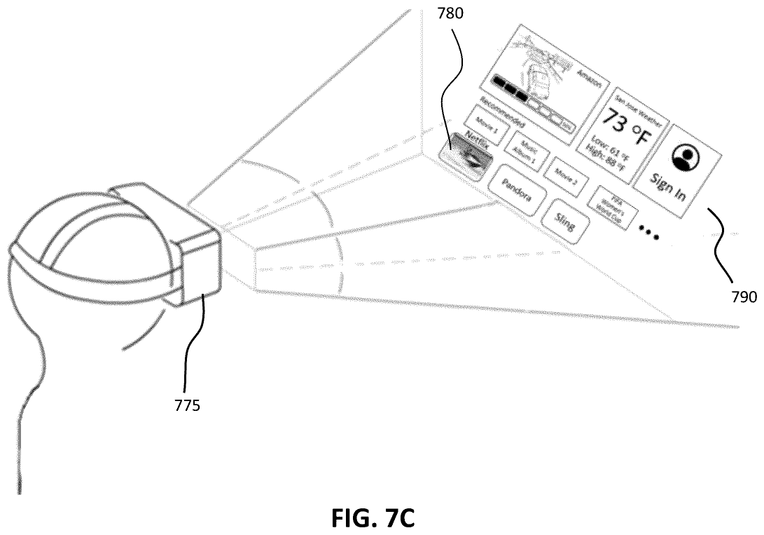

In another example, the display device may be a virtual, augmented, or mixed reality device, collectively referred to as an extended reality (XR) device on which a home screen of a content aggregator may be displayed. The XR device may be XR glasses or a headset, as displayed in FIG. 7C. The user interface of the content aggregator may be displayed on a virtual screen visible via the XR device. The icons for executable applications may be displayed on a home screen of the user interface depicted via the XR device. A user's gaze may be tracked in such a device to determine whether the user is interacting with a particular icon.

The embodiments of the content aggregator's user interface displaying a home screen, as well as all examples of various user interfaces and platforms discussed above, may include icons that are associated with executable applications. For example, an icon depicting the word Prime may be associated with a streaming media service provided by Amazon Prime™ Likewise, an icon with an image of the letter “N” colored in red may be associated with a streaming video service known as Netflix™. The icons, also referred to as tiles herein, may be a still image or text in a predefined area. The embodiments of the content aggregator's user interface displaying a home screen, as well as all examples of various user interfaces and platforms discussed above, may also include web applications, such as those that manage the home screen. Such web applications may call a web renderer to execute a webpage render of a remote OTT executable application.

Icons may be of any shape and may vary from one user interface of a content aggregator to another. For example, an icon may be in the shape of a square, rectangle or circle. They may vary in size and format. The applications associated with the icons may be of any type and may vary from user interface to user interface and may also include any new executable applications that are downloaded by a user from the internet and stored on the home screen of the user interface.

At block 101, the home screen displayed includes a section at the bottom with icons associated with executable applications. These icons, in this embodiment, are Netflix™, Sling™, Pandora™, Amazon Prime or Prime Video™, Max™ and partially visible icon of Hulu™. Although icons for Netflix™, Sling™, Pandora™, Amazon Prime or Prime Video™, HBO Max™ are displayed, the icon may be for any other type of streaming video or audio or another type of media application. The icons may also be displayed in other locations on the home screen of the user interface, such as the user interface of a content aggregator, besides at the bottom of the home screen as displayed.

At block 102, the control circuitry of a system, such as the system displayed in FIG. 2 with control circuitry 200 and/or 228 which may be associated with an operating system of the content aggregator platform, and may be software or hardware, may determine a selection criterion for selecting any one or more icons associated with executable applications for using the icon as an active media tile. The term “active media tile” or “active icon,” as used herein, refers to a tile or icon that displays a video within the confines or the boundary of the icon associated with an executable application without launching the underlying executable application. It also refers to displaying the application logo's name, such as Netflix, while playing the video within the confines or the boundary of the icon. In this scenario, the video may play as an underlay of the original static icon. It also refers to a tile or icon that is enlarged upon hovering or selecting and a video being played within the confines, or the boundary of the enlarged tile or icon associated with an executable application without launching the underlying executable application. It also refers to a tile or icon that plays an audio file for that icon associated with an executable application without launching the underlying executable application. For example, an active media tile might play a video montage within the boundary of the Netflix icon instead of a still image without launching the application for Netflix, as will be described in further detail below. All such files, audio, video and rolling text are collectively referred to herein as content files, content items, manifest files, and/or multimedia files.

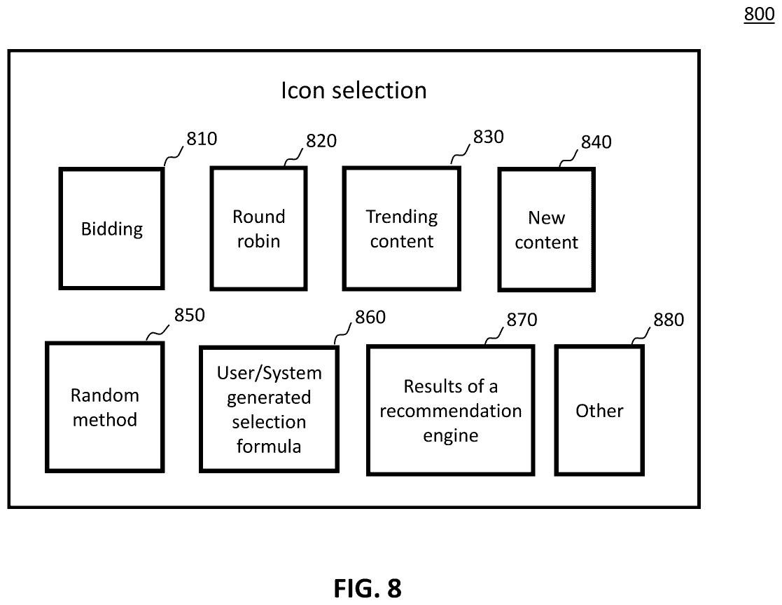

The control circuitry 200 and/or 228 may determine which icon to select based on any one or more of the following criteria: bid winner, round robin, trending content, new content, random method, user/system generated selection formula, or results from a recommendation engine, such as an AI or ML engine. The control circuitry 200 and/or 228 may also determine which icon to select based on some other formula or criteria generated by the control circuitry 200 and/or 228, suggested by an artificial intelligence (AI) algorithm, or inputted by a user of the user interface of the content aggregator. Some examples of selection criteria are further described in relation to the description of FIG. 8.

In some embodiments, one of the criteria for selecting an icon, among the plurality of icons displayed on the home screen of a user interface, is bidding. In these embodiments, the control circuitry 200 and/or 228 may receive a plurality of bids from one or more service providers that are associated with the executable application. The service providers may send a bid, which includes a price, identification of content that is to be displayed within the icon of the service provider displayed on the home screen, and any other details associated with the bid. For example, the additional details may specify the genre of the content, the timing of the content, and the duration of the content that is to be displayed within the icon associated with the service provider. The control circuitry 200 and/or 228 may also send a request for bids to some or all the service providers for whom an icon is displayed on the home screen of its user interface. It may also send a request for bids to certain selected service providers associated with certain selected icons, from the plurality of icons, displayed on the user interface of the content aggregator.

The bidding process may be used by the control circuitry 200 and/or 228 to determine which icons to use as active media tiles and/or which active media tile gets the most bandwidth. Regardless of how the decision is made, or based on, to determine which tiles to make into active media tiles, once a determination is made, the control circuitry 200 and/or 228 may use a video player embedded in the icon to play the content, such as streaming video or audio indicated in the manifest file. The video player may be embedded in the icon or anywhere else on the user interface. In some instances, the video player may be instantiated once a determination is made that a video is to be played for certain icon. The video player may also be enlarged when the icon is enlarged. The video player instance created may be the resolution of the static image or icon and it may be enlarged and scaled in any direction (e.g., horizontal, vertical, 2×, 3× etc.) to make it bigger for visibility. In some embodiments, once the video has been played, and no subsequent videos are to be played, then the video player may be deleted to save resources.

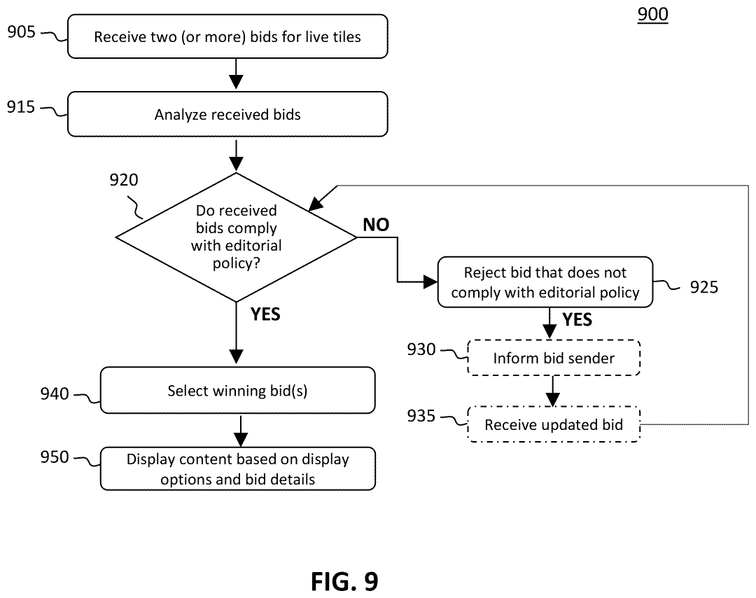

The number of video players available that may be activated concurrently depends on device capability (CPU, RAM) as well as bandwidth availability. In some embodiments, the operating system may limit the number of simultaneous video streams based on available bandwidth. In other embodiments, the number of available decoders (or associated licenses) may limit the number of video streams that can be played concurrently. As such, a bidding process may be used to manage bandwidth and other resources such that the service providers with the highest bid, or a bid that includes criteria that is most attractive for the user interface to engage its user, may be used by the control circuitry 200 and/or 228, such as the control circuitry that belongs in the operating system of the content aggregator platform, and may be software or hardware, to select one, or a selected number of icons, to make them active media tiles while retaining the other icons as still images. One embodiment of the bidding process is further described in relation to the description of FIG. 9.

Once the selection criteria for selecting one or more icons is determined at block 102, at block 103, the control circuitry 200 and/or 228 applies the selection criteria to select any one or more icons that are displayed on the home screen. In other embodiments, if a particular icon is not displayed on the home screen, and a determination is made that having such an icon would add value to the user, the control circuitry 200 and/or 228 may transmit a message to the associated service provider to place a bid for having their icon displayed on the home screen. In some embodiments, user approval may be sought prior to transmitting the message to the associated service provider to place a bid for having their icon displayed on the home screen.

In some embodiments, the Netflix icon is selected at block 103 based on the selection criteria from block 102. Although Netflix is used as an example, any other icon associated with an executable application that is also associated with a streaming video or audio service provider that recommends content items may also have been selected. Although a single icon is selected as an example, multiple icons associated with multiple executable applications may also have been selected.

At block 104, in one embodiment, the control circuitry 200 and/or 228, such as the control circuitry that belongs in the operating system of the content aggregator platform, and which may be software or hardware, determines the content type and display format for displaying in the boundary of the selected icon. The control circuitry 200 and/or 228 may also determine a type of audio file for playing for the selected icon. In another embodiment, the service provider, (e.g., Netflix) may indicate which content to play in the selected icon. This may also include any shows as well as a timestamp in the show from which to resume by auto playing (within the icon), a preview of the show, or the last 30 seconds of the current episode that the user has already watched and then display a resume option (in order to start watching in full screen mode). In yet another embodiment, the display device may have access to popular content, such as on Hulu, and may display a poster for the popular content within the icon or enlarged version of the icon (e.g., by replacing the enlarged app static image with a movie poster).

In some embodiments, the content aggregator may have visibility of the content being played in each active media tile. It may track such content and keep a list of what content is played in which active media tile. Having such visibility and keep track may allow better management of content being played across multiple active media tiles, such as by not repeating same type of content, same genre of content, etc. in multiple active media tiles.

In other embodiments, the content aggregator may have visibility of the content being played in various applications such as a Netflix app, a Hulu app or a FAST channel on the connected TV. In this embodiment, the connected TV OS is capable of running ACR to recognize content being played regardless of which app it is being watched on. Having such visibility provides the connected TV several advantages. For example, the connected TV may utilize such information in building tiles by informing the OTT service provider of such user consumption data. The OTT service provider may then use that information to send content that is relevant to the specific user. The content aggregator may also use such user data to request specific types of content from the OTT service provider that is in line or relevant to what the user has previously consumed. In other words, instead of sharing the consumption data with the OTT service provider, such as due to privacy reasons, the content aggregator may request a certain type of content from the OTT provider and the request may be based on learning what the user has consumed via other applications. As such, having such visibility may allow the content aggregator to decide what type of content to request and play in each tile based on what the OTT providers send and what they know of the viewer through their consumption patterns.

In all the embodiments, where content is played within the icon, when the icon is engaged, such as when a user hovers over the static icon, the content is displayed within the confines of the enlarged icon. In yet other embodiments, when the icon is showcased in a larger view somewhere on the user interface, i.e., at any location on the user interface, the content is displayed within the confines of the icon as it is presented on the user interface.

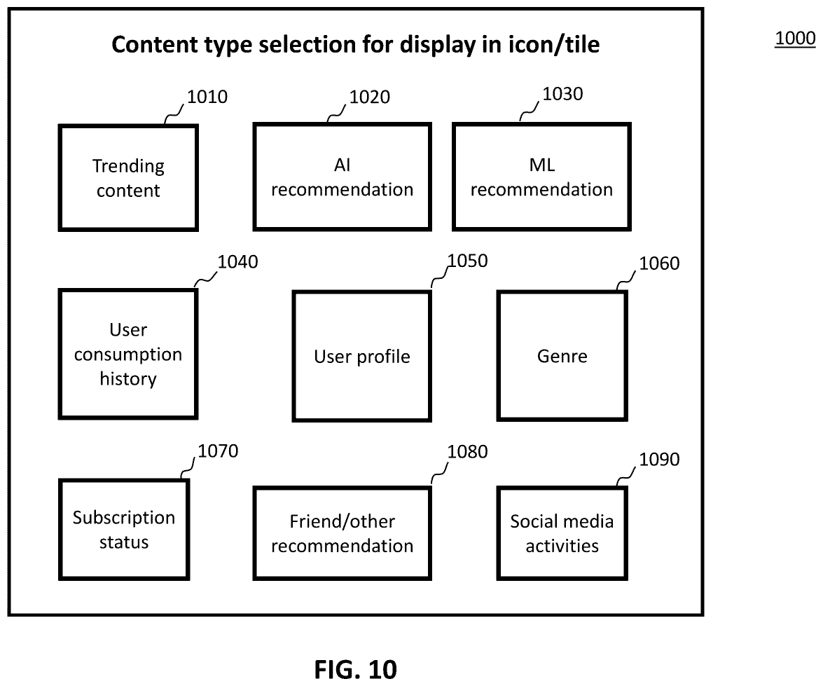

The content type may be selected by the control circuitry 200 and/or 228 based on one or more content type selections. In some embodiments, the content type selection may be based on any one or more of trending content, artificial intelligence (AI) recommendation, machine learning (ML) recommendation, user profile, genre, and/or subscription status of a user for the underlying executable application. The content type selection may also be based on any other criteria generated by the control circuitry 200 and/or 228 of a user of the user interface, such as the user interface of a content aggregator. Some examples of content selection are further described in relation to the description of FIG. 10.

In some embodiments, what type of content to use for displaying in an active media tile may be determined based on a recommendation from an ML engine. The ML engine may execute an ML algorithm to monitor user consumption of media asset. The ML algorithm may detect patterns, based on user consumption, of what types of media assets interest the user. For example, based on user consumption history, the ML engine may determine that the user has a pattern of consuming media assets that are action movies. Accordingly, the content whose genre is action may be recommended by the ML engine as the type to select for playing in an active media tile. Other examples of content type selection and the basis of the selection are further described in relation to the description of FIG. 10.

At block 104, the control circuitry 200 and/or 228, such as the control circuitry that belongs in the operating system of the content aggregator platform, and may be software or hardware, may also determine the display format for displaying in the boundary of the selected icon. The display format may either be defined by the control circuitry 200 and/or 228 or may be a format suggested by the service provider. For example, the service provider may determine that playing a trailer of their latest movie in the active media tile (i.e., within the boundary of the icon representing the service provider's executable application on the home screen) is the best option to engage its audience, thereby enticing them to select their executable application over other executable applications displayed on the home screen.

In some embodiments, the control circuitry/content aggregator operating system may not communicate any preference or profile information to the service provider (e.g., OTT service provider). In this case, the service provider may, at block 105, provide a manifest that is not personalized or customized for the viewer.

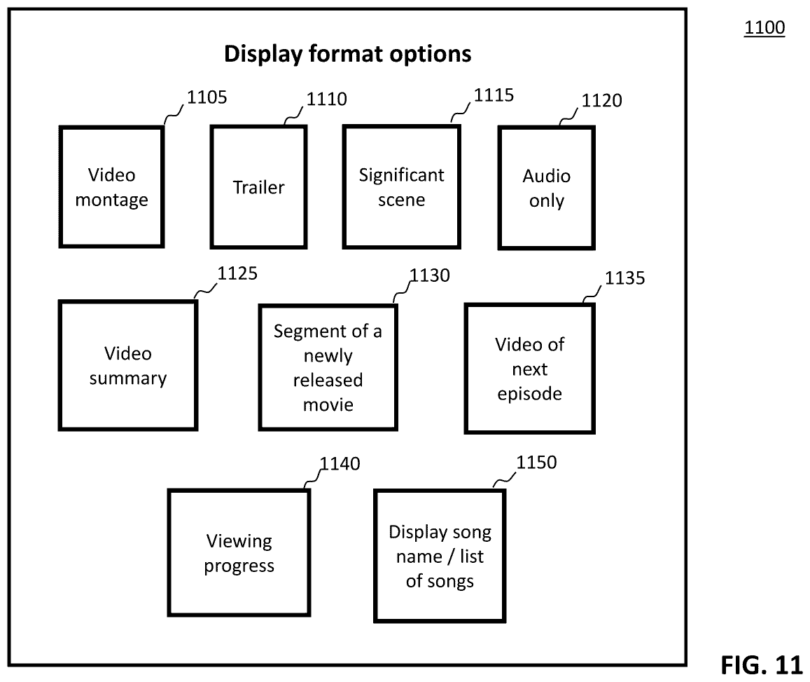

In some embodiments, the display formats may be any one of trailer, video montage, or video progress bar. In other embodiments, the display format may be a video summary that represents a plurality of shows provided by a service provider. For example, Netflix may generate a 10-second video summary of its popular shows to display in the Netflix icon for attracting users to click on their application. In another example, Netflix may generate a video summary for each of its popular shows and these may be appended to a larger 1-2-minute video. Instead of a video file, it may also be playing of an audio file and in some embodiments, it may be a combination of both audio and video. Other examples of display formats are further described in relation to the description of FIG. 11.

At block 105, the control circuitry 200 and/or 228 may obtain the manifest or content file and play the obtained content file at block 106 within the boundaries of the icon. Since the control circuitry 200 and/or 228 keeps a list of the applications installed on the home screen of the content aggregator, when a manifest file is received, which includes an application identifier, the control circuitry 200 and/or 228 matches the received manifest file with the correct application based on the application identifier. In some embodiments, the control circuitry 200 and/or 228, in addition to keeping a list of the applications on the home screen, may also store information relating their exact locations on the home screen, such as which row and column, update the locations as the icons are moved or rearranged, and keep a list of App IDs associated with each icon.

The manifest file may be obtained in several ways. These may include receiving a manifest upon startup of the display device or the user interface of the content aggregator. They may include initializing of the user interface or the home screen of the user interface. They may include requesting the manifest file from the service provider. They may include requesting a manifest file update. They may include accessing a manifest file from a storage. They may include a process of making an API call for obtaining the manifest file. They may include downloading the manifest file directly from the service provider. They may also include receiving a manifest file with URLs and instructions or how to sequentially use the URLs for obtaining files and playing them.

In one embodiment of block 105, the control circuitry 200 and/or 228 may share user information (e.g., device ID, account credentials) utilizing a descriptive file format such as XML (Extensible markup language) or JaveScript Object Notation (JSON) with all participating service providers whose executable applications are displayed on the home screen of the user interface, such as the user interface of a content aggregator. In addition to device ID and account credentials, the control circuitry 200 and/or 228 may also share other user information, such as user preferences, consumption history, etc. As described earlier, when the user consumes content using a service provider application, such as via Netflix, then Netflix may already be aware of the user's consumption history, their likes, dislikes, genre preferences etc. As such, the user consumption history that is shared with Netflix may be the user's consumption on other applications aside from Netflix and on live TV, which may be enabled by the content aggregator that is running automatic content recognition (ACR).

When sharing device ID and account credentials, the control circuitry 200 and/or 228 may also mask certain information due to privacy reasons. The control circuitry 200 and/or 228 may share the user information when the display device, such as a television, is turned on. The control circuitry 200 and/or 228 may also share the user information when the content aggregator home screen is invoked, such as by turning on the connected TV, which may be a smart TV, TV with streaming stick, or a TV connected communicatively to a set top box. The control circuitry 200 and/or 228 may also share the user information at any other times, for example, even when the display device is not turned on during the consumption of a media asset on the television. The service provider, i.e., the OTT service, in response to receiving user information, may then provide a manifest to the control circuitry 200 and/or 228. As described earlier, if the user consumes content using the OTT service, such as Netflix, and the Netflix icon is the one to be activated to play content, then, since Netflix already is aware of the consumption history and account details of the user, such information may not need to be shared. Netflix may use such stored information, such as from a user or account profile, in generating a manifest file. The manifest may include one or more URLs to content. The OTT service may utilize the user information to personalize the manifest transmitted to the control circuitry 200 and/or 228. The control circuitry 200 and/or 228 may receive the URLs or other video and audio files and initialize a video player associated with the icon that is associated with the OTT service. For example, it may initialize a video player embedded in a Netflix icon if the files received are from the service provider Netflix. The control circuitry 200 and/or 228 may continue to exchange user information with the service provider to enhance the level of customization. In one embodiment, the OTT service receiving may utilize additional personal data received to further personalize the manifest files sent to the control circuitry 200 and/or 228. This may also occur as an update check, where the control circuitry 200 and/or 228 periodically, or at scheduled intervals, provides additional user information and the version of its manifest to the service provider and in exchange receives an updated version of the manifest. In another embodiment, the OTT service may also have the personal information and user consumption history of a user since the user consumed content using the OTT service and may use such information to personalize the manifest files and sent to the control circuitry 200 and/or 228. When personal information is not available, a manifest file that is not personalized may be sent. The control circuitry 200 and/or 228 receiving the manifest may initialize the associated video player to then play the files as described at block 106.

In another embodiment of block 105, the process of obtaining the manifest or content file and using it to play the content in the icon boundaries includes the control circuitry 200 and/or 228, such as the control circuitry that belongs in the operating system of the content aggregator platform, and may be software or hardware, making a special API call on startup of the display device or upon launch of the home screen of the user interface to the service provider. The initialization with the display device and account parameters may be transmitted to the service provider to request the manifest file or the service provider may already be aware of the account parameters and use them in generating the manifest file without having to receive them. In some embodiments, control circuitry 200 and/or 228 may use such an initialization approach to request the manifest instead of receiving it on startup (when the connected TV operating system (OS) performs the action without intent to log in) from the action of logging in to an app (after which the content service takes over as the client). The control circuitry 200 and/or 228 may use encrypted protocols such as HTTPS (with TLS/SSL sublayer) to transfer user- and device-specific information to the service provider such that the service provider can use the information to transmit a manifest file that is suitable for the user and device. In some embodiments, the service provider may issue separate credentials to the control circuitry 200 and/or 228 (and/or the display device or the user) for requesting a manifest. These credentials may be transmitted during a content consumption session or via a separate encrypted protocol between the service provider and connected display device (or the TV OS or TV platform). Using this method, as described in this embodiment, the control circuitry 200 and/or 228 may transmit device and account parameters upon home-screen startup to the service provider and in response receive an updated manifest for playing content directly in the home screen, i.e., within the boundaries of the icon associated with the service provider.

In some embodiments related to block 105, the content or manifest file may be requested by the control circuitry 200 and/or 228 using the MPEG-DASH, CMAF protocols. In some embodiment, prior to requesting the content or manifest file, a determination may be made by the TV OS whether the OTT service provider even has an option for an active tile. For example, the TV OS may query the OTT service provider's platform for its capabilities. As part of the query, the TV OS may inquire, whether the OTT service provider supports live tile and if so, what type of API formats are requires, which version of DASH, MPEG is supported. The query may also include other information that may be needed to activate the icon for the service provider into a live media tile. Accordingly, the handshake may be performed between the TV OS and the OTT service provider to determine whether an active tile is to activate for the service provider and if so what are all the technical requirements needed to be complied to may their icon active.

In other embodiments related to block 105, the process of obtaining the manifest or content file and using it to play the content in the icon boundaries includes the control circuitry 200 and/or 228 downloading the manifest or content file and saving it in the memory of the display device directly from the OTT service provider rather than requesting it via a streaming protocol. The control circuitry 200 and/or 228 may then perform an update check directly on the version of the manifest file, to see if the service provider has a more recent version. The control circuitry 200 and/or 228 may send device and account credentials needed on startup or home-screen initialization to the service provider to obtain a manifest file that is personalized or related to the user's interests.

In other embodiments of block 105, a connected TV OS may receive a manifest file comprising multiple URLs that specify content of different genres, durations and other properties that are user profile dependent. The connected TV OS may create a user profile using ACR technology based on recent and historical content consumption (across one or more service provider executable applications). The TV OS may then select a sequence of short videos from the manifest for playing within a boundary of an icon based on the user profile. In instances where the icon is enlarged, moved to a different location on the user interface, or a larger version is displayed as an overlay when hovered upon, the TV OS may play the sequence of short videos content from the content file within the boundaries of the enlarged, moved, or overlayed icon.

In yet other embodiments of block 105, where multiple profiles may be registered with a service provider, such as multiple family members in the same household may be registered under different profiles with Netflix. When multiple profiles are registered, the service provider may present content related to a profile (e.g., based on time, frequency of access, and other patterns). Other identification technologies may be utilized (e.g., computer vision, voice profiles, etc.) to present content. The manifest file provided by the service provider may be generic, for example, when no user profile or other information is communicated by the connected TV OS (content aggregator) to a content provider service at block 104, or it may be customized for the user profile. For example, the manifest file provided by Netflix may specify various URLs, and the sequence of these URLs may be constructed based on content relevant to the user's watched shows or genre preferences.

The manifest file obtained, in some embodiments, may contain information for accessing the content item, such as via a URL, as well as information relating to various resolutions that are available for playback for the content item. It may also include information relating to location of the different segments and whether the content is available in a different language (audio), etc. The video player may use this information (it can parse the manifest file) in order to play back the content and to request lower bitrate content if there is not enough bandwidth that supports playing higher bitrate content (since that might introduce rebuffering, etc.

In some embodiments, the video player may be instantiated to play the content associated with the manifest file. The video player may be small in size (it may be the size of an icon or an enlarged icon). Since the size of the icon and the video player may be small, a high content resolution may not be needed to play content in the small sized video player. The content resolution of the icon may match that of the video player and vice versa. Accordingly, the manifest file may include a URL to a low-resolution version of the content item that is available for playback. If the user selects the icon and decides to watch the show or content featured, then the video player may be enlarged. When the video player is enlarged, to match the resolution of the video player, a higher resolution/bitrate content may be requested and if available provided. This may occur then transitioning from a small size icon to an enlarged icon for a full consumption of content.

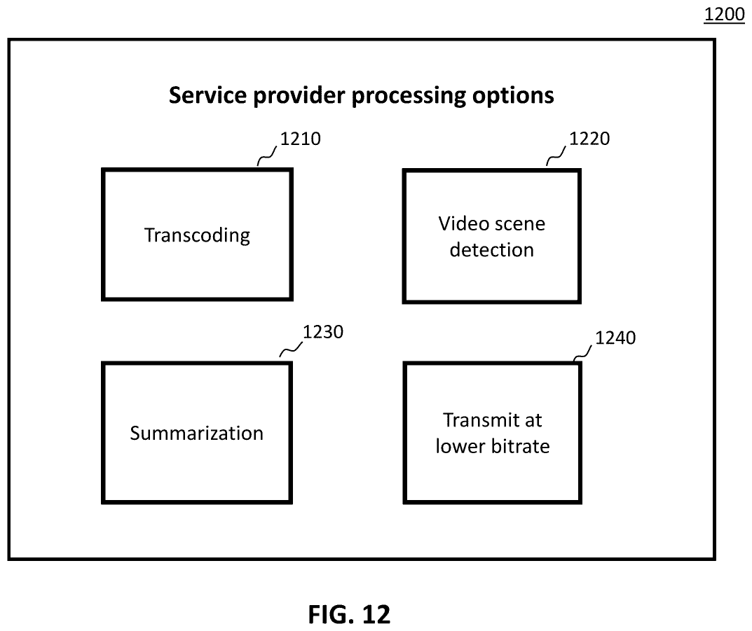

Which resolution to select, what version of from available versions of content to play may also be based on the winning bid from a service provider and what has been agreed to as part of the winning bid. For example, the service provider may bid a lower bid amount for playing the content at a lower bit rate and a higher bid amount for playing the content at a higher bit rate. Which resolution to select may also be determined by the TV OS recommendation engine. The content provided by the service provider may be communicated in the URLs provided by the service provider in the manifest file (ex., high bit rate vs low bit rate). Some examples of processing of the content file are further described in relation to the description of FIG. 12.

At block 106, once the content or manifest file is obtained, the control circuitry 200 and/or 228 may play the content file within the boundaries of the icon selected at block 103. In instances where the icon is enlarged, the associated video player may also be enlarged to match the icon size. The video player may also be scaled to a bigger size and overlayed on the icon. The video player may also be underplayed such that when it plays a video, the name of the OTT service provider is still visible. Once the content or manifest file is obtained, a playback API may direct decoded content from the manifest file to a video player for playing the content. Since each App on the home screen may have an App ID, and each manifest file received may indicate an App ID that corresponds to the manifest file, a match between the App ID included in the manifest file and the App may be determined prior to sending the decoded content to the video player associated with the icon of the App. The playback API may be aware of location of the App and its associated icon on the home screen, such as which row and column etc., and may redirect the decoded content to the corresponding video played of the icon. The playing of the content file may be done without launching the underlying executable application. The control circuitry 200 and/or 228, in some embodiments, may display the content file at the initial display of the home screen of the user interface of the content aggregator.

In other embodiments, the control circuitry 200 and/or 228 may display the content file periodically in the selected icon while the home screen is being displayed. For example, if the home screen is displayed and the user has not performed any maneuvers on the home screen (such as selecting an icon), then the control circuitry 200 and/or 228 may repeat the display of a content file for a selected icon every 30 seconds, two minutes, or at some other periodic interval.

In other embodiments, the control circuitry 200 and/or 228 may display the content on a continuous basis in the selected icon while the home screen is being displayed. For example, if the home screen is displayed and the user has not performed any maneuvers on the home screen (such as selecting an icon), then the control circuitry 200 and/or 228 may continuously display the content from the content file for a selected icon as long as the home screen is still being displayed.

In other embodiments, the control circuitry 200 and/or 228 may display the content from the content file when a user interacts with an icon, such as by hovering over the icon, scrolling to that icon using a remote control, but not selecting it, or gazing at the icon.

In yet other embodiments, the control circuitry 200 and/or 228, such as the control circuitry that belongs in the operating system of the content aggregator platform, and may be software or hardware, may display the content from the content file at every instance when the user returns to the home screen of the user interface of the content aggregator, such as from within an application back to the home screen.

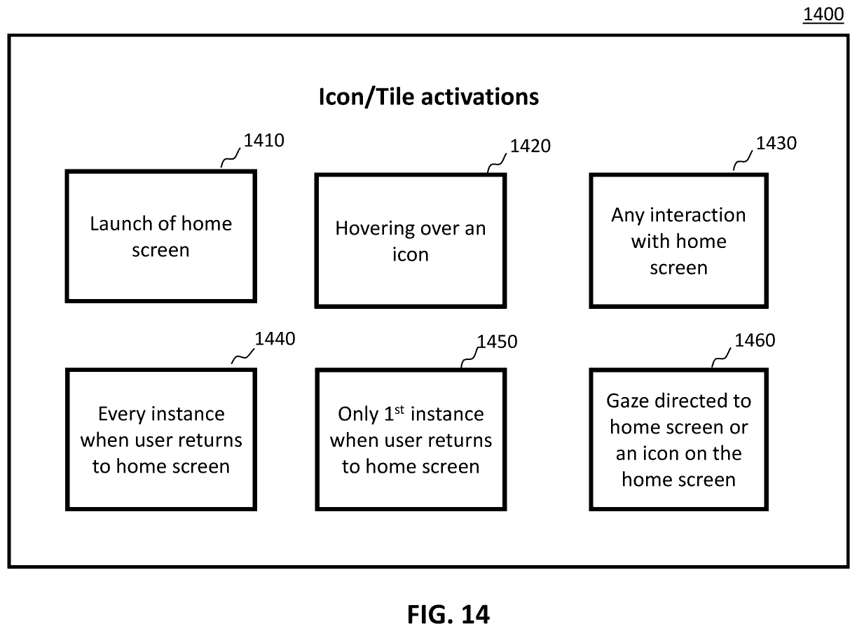

In yet more embodiments, when a user “ping-pongs” (performs back and forth maneuvers) between icons, the control circuitry 200 and/or 228 may implement a short wait time when the user scrolls to an icon before it plays the content file. The short wait may be implemented, in some embodiments, to fetch new content since the user may have already seen content displayed earlier when the user ping-ponged back and forth. The short wait may also be implemented to save resources by not having to replay the same content since a prediction may be made that the user is likely to ping-pong away from the icon again. In other embodiments, despite of the ping-pong maneuver, the content may be repeated to the user and played within the icon. Some examples of activating display of the content file are further described in relation to the description of FIG. 14.

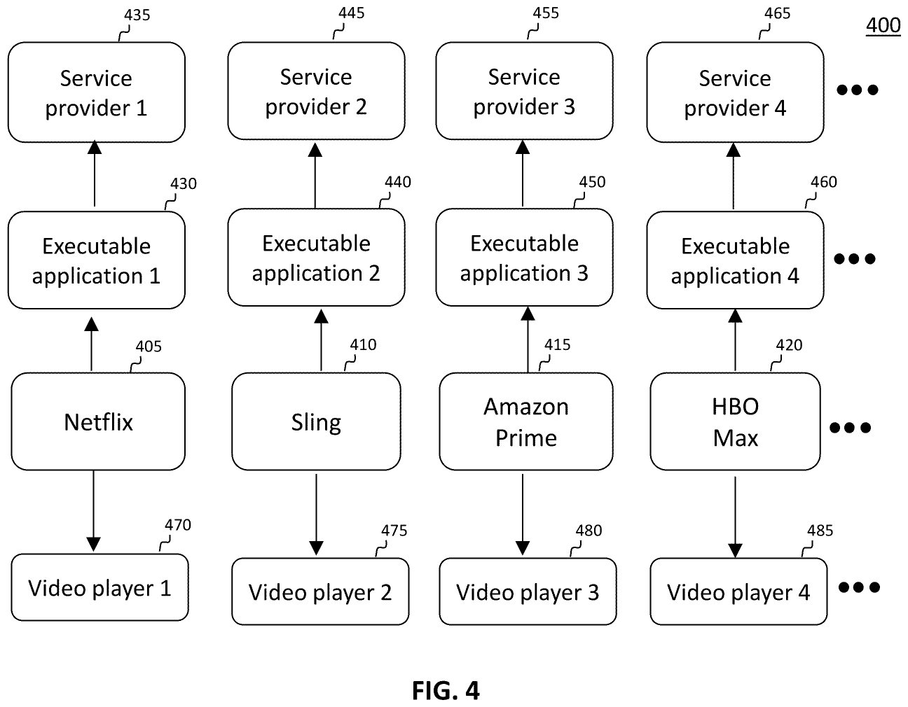

The playing of the content file at block 106 is performed by video players that are embedded in each icon. In some embodiments, the control circuitry 200 and/or 228 may embed a video player for each icon. For example, if the icons displayed are associated with executable applications for Netflix, Sling, Amazon Prime or Prime Video, and HBO Max, as displayed in FIG. 4, then the control circuitry 200 and/or 228 may embed a separate video player for Netflix within the Netflix icon, a separate video player for Sling within the Sling icon, a separate video player for Amazon Prime or Prime Video within the Amazon Prime icon, and a separate video player for HBO Max within the HBO Max icon.

The number of available video players that can be activated concurrently depends on device capability (CPU, RAM) as well as bandwidth availability. For example, the control circuitry 200 and/or 228 may limit the number of simultaneous content streams based on available bandwidth. In some embodiments, the number of available decoders (or associated licenses) may limit the number of content streams that can be played concurrently. For example, if the device has a decoder capable of handling only one video stream, then when the user navigates to a new icon, the previous stream may be paused.

Since different OTT service providers may opt to use different codec choices (e.g., HEVC, AVC, VP9, AV1, etc.), the on-TV decoder system on chip (SoC) will be configured to meet the requirements of simultaneously decoding received streams in different formats. Such information relating to codes used may be determined during a handshake process between the OTT service provider and the TV OS. Likewise, the handshake process may also be used to determine each other's capabilities and to synchronize all technical requirement for enabling the icon into a live media tile. In the case of mismatch in decoding capability vs. received bitstreams, the icon of the undecodable stream can be moved to a non-display position, or still image content can be displayed. In addition, the requests of content streams can be optimized considering the decoder SoC's capability of handling different formats.

As depicted in block 106, in one embodiment, since a Netflix icon was selected at block 103, the Netflix icon is made into an active media tile and a video file showing a jet ski is displayed. Any other type of video file or display format options, as depicted at block 11, may be used to provide a display in the selected Netflix icon.

At block 107, the control circuitry 200 and/or 228 may perform updates. In some embodiments, the update may be to request an updated content file from the service provider. In this embodiment, the control circuitry 200 and/or 228 may perform an update check, such as periodically, upon a set interval, or upon obtaining additional user data, such as new user consumption data, and transmit the device or user information to the service provider to obtain an updated manifest file. The control circuitry 200 and/or 228 may also ping the service provider on a periodic basis, or at set intervals, to determine if the service provider has a more recent version. For example, Netflix may update what they wish to feature and display on a user interface, within their icon, on a regular basis to keep the content updated and fresh. They may update such content, for example, when a new show or movie is available, to attract their audiences. In some embodiments, the control circuitry 200 and/or 228 may initially receive a generic manifest file and it may request an updated manifest file after user data is available such that an updated manifest file that is customized and/or personalized for the user can be obtained.

Yet another type of update performed by the control circuitry 200 and/or 228 includes rearranging the order of icons displayed on the home screen of the user interface of the content aggregator. The control circuitry 200 and/or 228 may also remove certain icons altogether if they're not being utilized or if a determination is made that the icon is not relevant based on the user consumption history. The control circuitry 200 and/or 228 may also feature a certain icon and content displayed in the icon at a larger scale. The control circuitry 200 and/or 228 may also reorganize the user interface such as by removing a sponsored section or replacing the sponsored section with a selected icon and playing the content file within the selected icon. In instances where the icon is enlarged, moved to a different location on the user interface, or a larger version is displayed as an overlay when hovered upon, the content from the content file is played within the boundaries of the enlarged, moved, or overlayed icon.

As an example, depicted at block 107, the control circuitry 200 and/or 228 may switch places of the Netflix and Amazon icons such that a selected icon is placed at the start of the icon list. The control circuitry 200 and/or 228 may also remove the sponsored content and replace it with the icon for Pandora™, which may be used to play an audio file from the sponsored section. Although some examples of icon rearrangements, enlargements and enhancements are described, the embodiments are not so limited, and any other types of manipulation of the user interface home screen for displaying the icons in a different manner are also contemplated.

FIG. 2 is a block diagram of a system for displaying or playing media content within an icon associated with an executable application and displayed on a home screen of a user interface, in accordance with some embodiments of the disclosure.

FIGS. 2 and 3 also describe example devices, systems, servers, and related hardware that may be used to implement processes, functions, and functionalities described at least in relation to FIGS. 1, 4-19. Further, FIGS. 2 and 3 may also be used for displaying a home screen of a content aggregator, displaying a user interface, such as a user interface of a content aggregator, that displays a plurality of executable applications, on the home screen, displaying icons of OTT service providers on the home screen of a content aggregator, determining a selection criterion for selecting any one or more icons associated with executable applications for using the icon as an active media tile, determining whether more than one icon is to be made into an active media, using selection methods, such as bid winner, round robin, trending content, new content, random method, user/system generated selection formula, or results from a recommendation engine, such as an AI or ML engine tile, to select an icon for making it into an active media tile, using bids form OTT service providers to determine which icons to make active, using bids form OTT service providers to determine how to allocate bandwidth between multiple active media tiles or how to order and present them on the home screen, determining triggers for activating an active media tile, instantiating video players to play videos within icons making them active media tiles, playing videos within the icon boundaries without launching their related executable applications, determining bandwidth allocation between multiple active media tiles, obtaining manifest files from OTT providers and accessing content referenced in the manifest files, requesting updated manifest files, monitoring user interactions with icons, determining whether the video has been played in the icon already and if so requesting updated or fresh content, and performing functions related to all other processes and features described herein.

In some embodiments, one or more parts of, or the entirety of system 200, may be configured as a system implementing various features, processes, functionalities and components of FIGS. 1, 4-19. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., list of icons, list of executable applications associated with each icon, location of the icon on the home screen, type of content displayed within each active media tile, user preferences, user consumption history, bids and related information from OTT service providers, list of video players and their association with icons, list of triggers to instantiate the video player, processing options provided by OTT service providers, editorial policies, list of durations of display for each video to be played in an active media tile, bandwidth allocations for each active media tile, and AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to list of icons, list of executable applications associated with each icon, location of the icon on the home screen, type of content displayed within each active media tile, user preferences, user consumption history, bids and related information from OTT service providers, list of video players and their association with icons, list of triggers to instantiate the video player, processing options provided by OTT service providers, editorial policies, list of durations of display for each video to be played in an active media tile, bandwidth allocations for each active media tile, executable application for various OTT service providers, and AI and ML algorithms, and data relating to all other processes and features described herein, may be recorded and stored in one or more of storages 212, 238.

In some embodiments, control circuitries 220 and/or 228 executes instructions for an application stored in memory (e.g., storage 224 and/or storage 238). Specifically, control circuitries 220 and/or 228 may be instructed by the application to perform the functions discussed herein. In some implementations, any action performed by control circuitries 220 and/or 228 may be based on instructions received from the application. For example, the application may be implemented as software or a set of executable instructions that may be stored in storage 224 and/or 238 and executed by control circuitries 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining that a trigger has been activated, the control circuitry 228 may instantiate a video played associated with that icon, access content referenced in a manifest file from an OOT service provider of that icon and play the accessed video content within the boundaries of the icon without executing the associated executable application. It may also perform steps of processes described in FIGS. 1, 5-6, 9, 15 and 19, including determining selecting an icon for making into an active media tile, accessing content referenced in a manifest file from an OOT service provider of that icon, and playing the accessed video content within the boundaries of the icon without executing the underlying executable application.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as user preferences, device and user data, bids from OTT service providers, manifest files from OTT service providers and input from primary devices and secondary devices, such as connected TV, set top boxes, and other such devices. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, a virtual, augmented, or mixed reality device (XR devices), or any other device, computing equipment, or wireless device, and/or combination of the same capable of displaying a home screen of a user interface, where the home screen displays icons associated with executable applications linked to an OTT service provider.

Control circuitries 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores).

In some embodiments, processing circuitry may be distributed across multiple separate processors, for example, multiple of the same type of processors (e.g., two Intel Core i9 processors) or multiple different processors (e.g., an Intel Core i7 processor and an Intel Core 19 processor). In some embodiments, control circuitries 220 and/or control circuitry 218 are configured for displaying a home screen of a content aggregator, displaying a user interface, such as a user interface of a content aggregator, that displays a plurality of executable applications, on the home screen, displaying icons of OTT service providers on the home screen of a content aggregator, determining a selection criterion for selecting any one or more icons associated with executable applications for using the icon as an active media tile, determining whether more than one icon is to be made into an active media, using selection methods, such as bid winner, round robin, trending content, new content, random method, user/system generated selection formula, or results from a recommendation engine, such as an AI or ML engine tile, to select an icon for making it into an active media tile, using bids form OTT service providers to determine which icons to make active, using bids form OTT service providers to determine how to allocate bandwidth between multiple active media tiles or how to order and present them on the home screen, determining triggers for activating an active media tile, instantiating video players to play videos within icons making them active media tiles, playing videos within the icon boundaries without launching their related executable applications, determining bandwidth allocation between multiple active media tiles, obtaining manifest files from OTT providers and accessing content referenced in the manifest files, requesting updated manifest files, monitoring user interactions with icons, determining whether the video has been played in the icon already and if so requesting updated or fresh content, and performing functions related to all other processes and features described herein.

Computing device 218 receives a user input 204 at input circuitry 216. For example, computing device 218 may receive data relating to list of icons, list of executable applications associated with each icon, location of the icon on the home screen, type of content displayed within each active media tile, user preferences, user consumption history, bids and related information from OTT service providers, list of video players and their association with icons, list of triggers to instantiate the video player, processing options provided by OTT service providers, editorial policies, list of durations of display for each video to be played in an active media tile, bandwidth allocations for each active media tile, and AI and ML algorithms.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5-6, 9, 15 and 19, respectively.

FIG. 3 is a block diagram of a display device, such as a connected TV, for displaying or playing media content within an icon associated with an executable application and displayed on a home screen of a user interface, in accordance with some embodiments of the disclosure.

In an embodiment, the equipment device 300, is the same equipment device 202 of FIG. 2. The equipment device 300 may receive content and data via input/output (I/O) path 302. The I/O path 302 may provide audio content (e.g., such as in the speakers of the connected TV). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or 19 processor).

In client-server-based embodiments, the control circuitry 304 may include communications circuitry suitable for displaying a home screen of a content aggregator, displaying a user interface, such as a user interface of a content aggregator, that displays a plurality of executable applications, on the home screen, displaying icons of OTT service providers on the home screen of a content aggregator, determining a selection criterion for selecting any one or more icons associated with executable applications for using the icon as an active media tile, determining whether more than one icon is to be made into an active media, using selection methods, such as bid winner, round robin, trending content, new content, random method, user/system generated selection formula, or results from a recommendation engine, such as an AI or ML engine tile, to select an icon for making it into an active media tile, using bids form OTT service providers to determine which icons to make active, using bids form OTT service providers to determine how to allocate bandwidth between multiple active media tiles or how to order and present them on the home screen, determining triggers for activating an active media tile, instantiating video players to play videos within icons making them active media tiles, playing videos within the icon boundaries without launching their related executable applications, determining bandwidth allocation between multiple active media tiles, obtaining manifest files from OTT providers and accessing content referenced in the manifest files, requesting updated manifest files, monitoring user interactions with icons, determining whether the video has been played in the icon already and if so requesting updated or fresh content, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths.

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., list of icons, list of executable applications associated with each icon, location of the icon on the home screen, type of content displayed within each active media tile, user preferences, user consumption history, bids and related information from OTT service providers, list of video players and their association with icons, list of triggers to instantiate the video player, processing options provided by OTT service providers, editorial policies, list of durations of display for each video to be played in an active media tile, bandwidth allocations for each active media tile, executable application for various OTT service providers, and AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, displaying videos within active media tiles, executing the OTT executable applications when selected, and performing all the functionalities discussed associated with the figures mentioned in this application.

FIG. 4 is a block diagram of a system having a video player embedded within an icon/tile for playing a video or audio file within the icon/tile, in accordance with some embodiments of the disclosure.

In some embodiments, multiple video players, such as multiple lightweight video players, are instantiated at various times based on user navigation (e.g., scrolling) at the home screen level in the user interface of the content aggregator. Such video players are embedded within the icon boundary area. They are overlayed by their corresponding application icons. They may also be underplayed such that the name of the OTT service provider is displayed when the video player plays the video within the icon.

In one embodiment, a video player for playing content within a Netflix icon may be instantiated and its location may be underneath where the Netflix icon is located on the home screen of the user interface. In another embodiment, the static icon (logo) frame itself may be looped as a video inside of the video player. In yet other embodiments, the video player may be embedded in the icon or anywhere else on the user interface. In some instances, the video player may be instantiated once a determination is made that a video is to be played for certain icon. The video player may be instantiated after such a determination has been made. In some embodiments, once the video has been played, and no subsequent videos are to be played, then the video player may be deleted to save resources.

In order to correctly locate the corresponding video player, the control circuitry 200 and/or 228, and/or the operating system of the display device, such as the TV OS, may keep track of the location (e.g., index) of the icons and their executable application in the home screen of the user interface. The icon associated with the executable application may be overlaid on the video player to indicate the source of the content.

As depicted in FIG. 4, the four icons that are displayed on the home screen of the user interface of the content aggregator are Netflix 405, Sling 410, Amazon 415, and HBO Max 420. The executable application associated with Netflix 405 may be executable application 1 (430). The executable application 1 430 may be associated with the service provider 1 (435), which in this case is Netflix. The video player that may be instantiated for the Netflix icon 405 may be video player 1 (470). This video player 470 may be located such that the Netflix icon 405 overlays the video player 470. When a determination is made to play content within the boundaries of the Netflix icon 405, then the control circuitry may activate video player 1 (470) such that content provided from the service provider 1 (435) can be played within the Netflix icon 405.

Likewise, the executable application associated with Sling 410 may be executable application 2 (440). The executable application 2 (440) may be associated with the service provider 2 (445), which in this case is Sling. The video player that may be instantiated for the Sling icon 410 may be video player 2 (475). This video player 475 may be located such that the Sling icon 410 overlays the video player 475. When a determination is made to play content within the boundaries of the Sling icon, then the control circuitry may activate video player 2 (475) such that content provided from the service provider to 445 can be played within the Sling icon 410.

In another embodiment, the executable application associated with icon for Amazon Prime 415 may be executable application 3 (450). The executable application 3 (450) may be associated with the service provider 3 (455), which in this case is Amazon Prime 415. The video player that may be instantiated for the icon for Amazon Prime 415 may be video player 3 (480). This video player 480 may be located such that the icon for Amazon Prime 415 overlays the video player 480. When a determination is made to play content within the boundaries of the Amazon Prime icon, then the control circuitry may activate video player 3 (480) such that content provided from the service provider 455 can be played within the icon for Amazon Prime 415.

In yet another embodiment, as depicted in FIG. 4, the executable application associated with icon for HBO MAX 420 may be executable application 4 (460). The executable application 4 (460) may be associated with the service provider 4 (465), which in this case is HBO MAX. The video player that may be instantiated for the icon for HBO MAX 420 may be video player 4 (485). This video player 485 may be located such that the icon for HBO MAX 420 overlays the video player 485. When a determination is made to play content within the boundaries of the HBO MAX icon 420 then the control circuitry may activate video player 4 (485) such that content provided from the service provider to 465 can be played within the icon for HBO MAX 420.

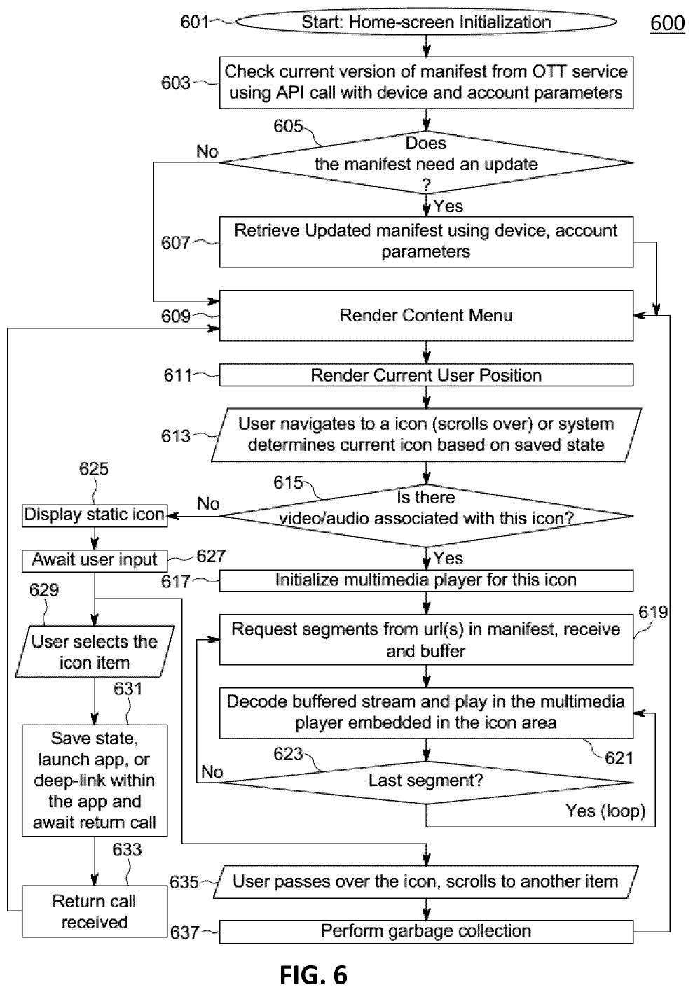

The video players may be activated or triggered at any of the times when active media tile is activated. Some examples of activating display of the content file, including the activation triggers, are further described in relation to the description of FIG. 14. In some embodiments, the video player may be initialized when a user scrolls or navigates away to an icon, as depicted in FIG. 6.

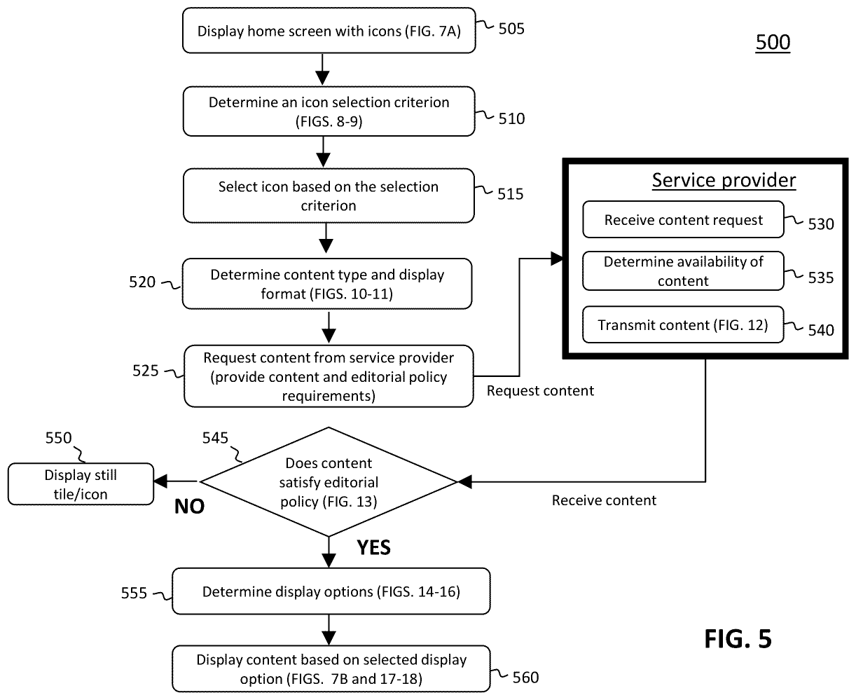

FIG. 5 is a flowchart of a process for displaying or playing media content within an icon associated with an executable application and displayed on a home screen of a user interface, in accordance with some embodiments of the disclosure. The process 500 may be implemented, in whole or in part, by systems or devices such as those shown in FIGS. 2-4. One or more actions of the process 500 may be incorporated into or combined with one or more actions of any other process or embodiments described herein. The process 500 may be saved to a memory or storage (e.g., any one of those depicted in FIGS. 2-3) as one or more instructions or routines that may be executed by a corresponding device or system to implement the method 500.

In some embodiments, at block 505, a home screen of a user interface of the content aggregator is displayed on a display device. The display device, for example, may be a television, a personal computer (PC), a laptop computer, a tablet computer, a smartphone, or a virtual, augmented, or mixed reality device.

The user interface of the content aggregator may differ from type of display device and the brand of the display device. For example, a home screen of a user interface of a Roku software downloaded on a television may differ from a home screen of a user interface for a Samsung television. The user interface may display a plurality of icons that are associated with a plurality of executable applications. These applications may be to streaming video and audio service providers, such as Netflix, Pandora, etc.

Although a television or similar display device has been used for describing the embodiments, the embodiments are not so limited and any other display device, including display devices that are in an autonomous car, such as the display screen used for displaying Apps or navigation, or a display of a XR device, is also contemplated. One example of a display of a home screen user interface is depicted at FIG. 7A. Another example of a display of a home screen for an XR device is depicted in FIG. 7C. Yet another example may set top boxes that are associated with user interfaces that display icons of executable application from various OTT service providers, such as cable operators.

At block 510, the control circuitry 200 and/or 228, such as the control circuitry that belongs in the operating system of the content aggregator platform, and may be software or hardware, may determine a selection criterion for selecting any one or more icons displayed on the home screen of the user interface of the content aggregator. The control circuitry 200 and/or 228 may determine which icon to select based on any one or more of the following criteria as depicted in FIGS. 8-9. For example, bidding may be used as a selection criterion for selecting any one or more icons displayed. The control circuitry 200 and/or 228 may make one or the icons an active media tile to play a content file within the icon based on the bids received by the associated service providers. It may select the highest bid to make only that icon active that has won the bid. It may also select the top two or three bids and make those two or three icons active as active media tiles to simultaneously play content within those icons.

At block 515, the control circuitry 200 and/or 228 may apply the selection criteria to select any one or more icons that are displayed on the home screen. For example, the control circuitry 200 and/or 228 may apply a select next approach in which it may sequentially select a next icon that is displayed in the row of icons to make active. In another example, the control circuitry 200 and/or 228 may determine which service provider has the most trending content and select the icon associated with that service provider to make active.

At block 520, in some embodiments, the control circuitry 200 and/or 228 may determine what type of content is to be played within the boundaries of a selected icon. In other embodiments, rather than the control circuitry 200 and/or 228 making the determination of the content type, the service provider may push content that it wants to showcase to the control circuitry 200 and/or 228. In still other embodiments, the control circuitry 200 and/or 228 provides user data to the service provider for the service provider to determine a suitable and relevant content type. The selection of the content type, once made, is used to generate a content file for playing within the selected icon. In addition to the control circuitry 200 and/or 228 or the service provider, or combination thereof, making a determination, content type selection may also be suggested based on AI, ML, or user profile recommendations. Some examples of content selection are further described in relation to the description of FIGS. 10-11.

In some embodiments, the control circuitry 200 and/or 228 may, in addition to determining content type, also determine a format in which the content is to be played. In other embodiments, rather that the control circuitry 200 and/or 228 determining the format, the service provider may generate a content file that has a certain format and push the content file to the control circuitry 200 and/or 228. In yet other embodiments, the format may be determined by a combination of both the control circuitry 200 and/or 220 and the service provider. Trailer, video montage and viewing progress are some examples in which the display may be provided. Other examples of display formats are further described in relation the description of FIG. 11.

At block 525, in some embodiments, the control circuitry 200 and/or 228, such as the control circuitry that belongs in the operating system of the content aggregator platform, and may be software or hardware, may request content from the service provider that is associated with the selected icon. The content may be obtained, such as through a manifest file, and played within the selected icon. One method of obtaining the content file may include receiving a manifest upon startup of the display device or the user interface. The control circuitry 200 and/or 228, in some embodiments, may make an API call to the service provider for obtaining the content file after receiving the manifest. Another method of obtaining the content file may include receiving a manifest upon invoking the Connected TV home screen, or a content aggregator home screen. Yet another method may include the control circuitry 200 and/or 228 directly downloading the manifest file from the service provider. The manifest file may include the content for playing or may include URLs and instructions or how to sequentially use the URLs for obtaining files and playing them. The control circuitry 200 and/or 228 may also share user information (e.g., device ID, account credentials) and any other information with all participating service providers whose executable applications are displayed on the home screen of the user interface. The service provider, e.g., the OTT service, in response to receiving user information, may then provide a manifest to the control circuitry 200 and/or 228 that is customized and personalized based on the received information. For example, if the service provider determines from the shared information that the user enjoys comedy, then the manifest file may be personalized to include a montage of all the shows that can be accessed through that service provider that relate to comedy.

In one embodiment, where the manifest file is requested by the control circuitry 200 and/or 228, the service provider, at blocks 530, 535, and 540 may receive the request, determine availability of requested content, and transmit the content using any of the techniques as described in FIG. 12.

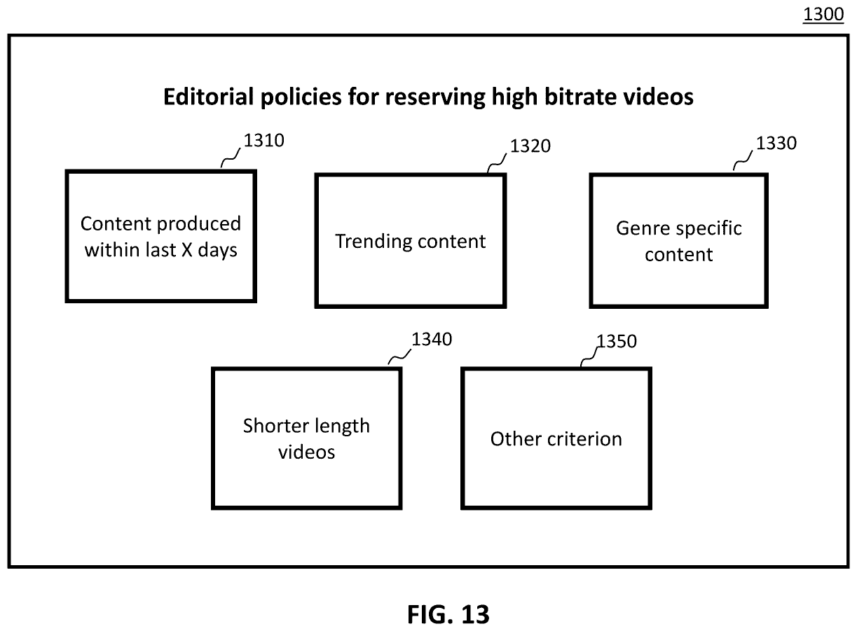

At block 545, the control circuitry 200 and/or 228 may determine whether the received content satisfies editorial policies of the user interface of the content aggregator and/or the display device. In some embodiments, the control circuitry 200 and/or 228 may specify a plurality of editorial policies that are required to be followed by a service provider in order for the content to be displayed within the icon associated with the service provider. These editorial policies may indicate genre of the content, such as PG-13 or action only. The editorial policies may also restrict the length of the videos that are to be provided by the service provider, such as to 10-15 seconds. The editorial policies may indicate that only trending content may be included in the manifest file provided by the service provider. The control circuitry 200 and/or 228 may generate any other type of editorial policy and require the service provide to follow it in order for their provided manifest file to be displayed within the boundaries of the selected icon. Some examples of types of editorial policies are further described in relation the description of FIG. 13.

If a determination is made at block 545 that the manifest file provided by the service provider does not satisfy the editorial policy, then the control circuitry 200 and/or 228 may display a still icon/tile for that service provider instead of making the icon an active media tile.

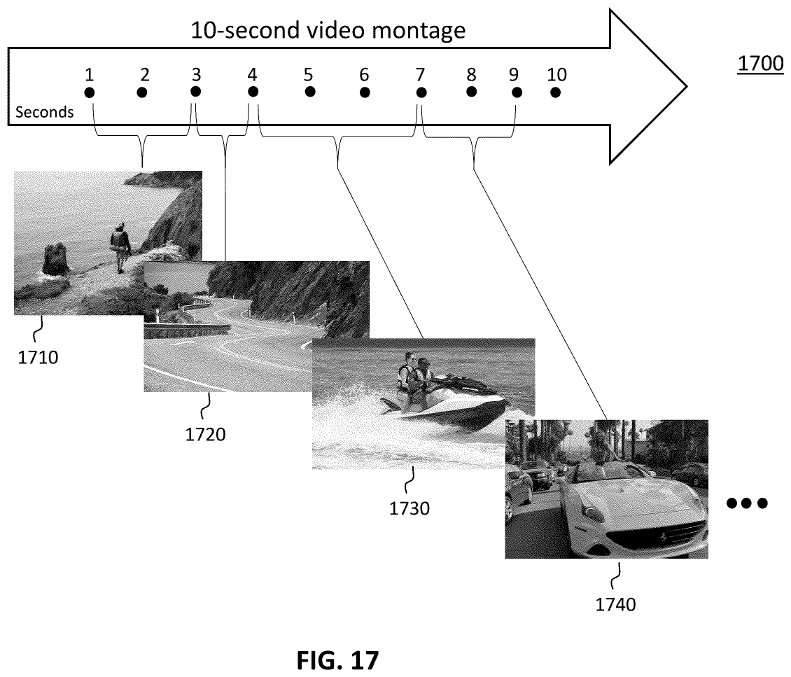

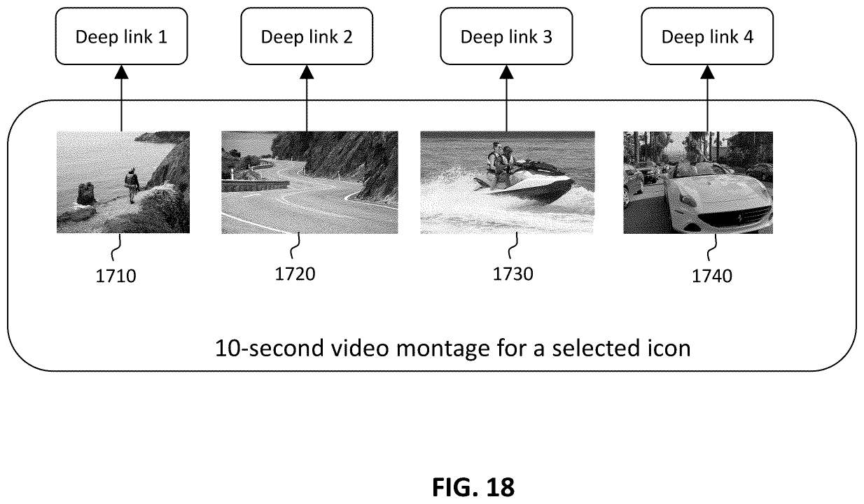

If a determination is made at block 545 that the manifest file provided by the service provider satisfies the editorial policy, then the control circuitry 200 and/or 228 may determine display options at block 555. Certain triggers may also be used to activate the display of the manifest file within the boundaries of the selected icon. Some examples of display options are further described in relation the description of FIGS. 14-16. Based on the selected display option, the manifest file may be displayed at block 560. The display of the manifest file may be done without launching the underlying executable application. One example of a display is provided in FIGS. 17-18.

FIG. 6 is a flowchart of a process for displaying or playing media content within an icon associated with an executable application and displayed on a home screen of a user interface, in accordance with some embodiments of the disclosure. The process 600 may be implemented, in whole or in part, by systems or devices such as those shown in FIGS. 2-4. One or more actions of the process 600 may be incorporated into or combined with one or more actions of any other process or embodiments described herein. The process 600 may be saved to a memory or storage (e.g., any one of those depicted in FIGS. 2-3) as one or more instructions or routines that may be executed by a corresponding device or system to implement the method 600.

In some embodiments, at block 601, the control circuitry 200 and/or 228 initializes the home screen. Initializing of the home screen, in one embodiment, is by displaying the home screen of the user interface on the display device.

At block 603, the control circuitry 200 and/or 228 may check its current version of a manifest file from the OTT service provider. It may do so by placing an API call with display device and account parameters of the user associated with the display device from the Connected TV OS to the content provider cloud.

At block 605, the control circuitry 200 and/or 228, such as the control circuitry that belongs in the operating system of the content aggregator platform, and may be software or hardware, determines whether the manifest file needs an update. If the manifest file does need an update, then, at block 607, the control circuitry may retrieve the updated manifest file using the display device and account parameters and then render the content menu at block 609. If the manifest file does not need an update, then, at block 609, the control circuitry may render the content menu.

At block 611, the control circuitry 200 and/or 228 may render the current user position. The current user position may be a position at which the user's mouse or TV remote control navigation is currently located on the display device or the home screen of the user interface of the content aggregator. The current user position may also be at an icon to which a user has navigated using a remote control. The current user position may also be on the connected TV or content aggregator home screen.

At block 613, the user associated with the display device or the user interface may navigate to an icon. The user may do that by scrolling over anywhere in the user interface or scrolling over the icon. The system, such via the control circuitry 200 and/or 228, may also determine the current location of the icon based on a saved state.

At block 615, the control circuitry 200 and/or 228 may determine whether there is an audio or video file associated with the icon. If an audio or video file does exist that is associated with the icon over which the user has scrolled over, then, at block 617 the control circuitry 200 and/or 228 may initialize the multimedia player associated with the icon.

The control circuitry 200 and/or 228 may then request segments from URLs in the manifest at block 619. The control circuitry 200 and/or 228 may receive the URLs in the manifest and buffer them.

At block 621, the control circuitry 200 and/or 228 may decode the buffered stream and play the audio or video file in the multimedia player embedded in the icon area. In other words, using the multimedia player, the control circuitry may display the content from the manifest file within the boundaries of the icon.

At block 623, the control circuitry 200 and/or 228 may determine if the segment played in the icon, such as a video, was the last segment. In other words, since multiple segments can be played back-to-back in the icon, the control circuitry 200 and/or 228 checks if another segment is to be played or the segment just played in the icon was the last segment. If it was the last segment, then the control circuitry may loop the last segment over and replay it again and again (or play from the starting of a first segment if the segment played is the last segment of multiple segments to be played). If a determination is made that it was not the last segment, then the control circuitry may request additional segments and URLs in the manifest file from the service provider.

Referring back to block 615, if there is no video or audio file that currently exists that is associated with the icon, then the control circuitry, at block 625, may display the static icon. Then the control circuitry, at block 627, may await user input, such as a selection of the icon, and, based on the user input, select the icon item at 629. At block 631, the control circuitry may launch the application for the icon that was selected. The control circuitry 200 and/or 228 may also deep-link the icon to a media asset and navigate the user to the deep-linked media asset. If a return call is received at block 633, then the control circuitry 200 and/or 228 may render the content menu based on the type of return call.

At block 635, if a user passes over the icon or scrolls to another item, then, at block 637, the control circuitry may perform garbage collection. In other words, in one embodiment, the control circuitry may flush the cache to clear memory of any user data for a previous icon when it is not selected. In doing so, it de-commissions, deactivates, or terminates the video player in the icon that has been passed over (opposite of initializing the video player) and de-allocates any memory associated with the video player in that icon.

FIG. 7A is a block diagram of a home screen of a user interface prior to executing an active media tile(s), in accordance with some embodiments of the disclosure. The user interface may be displayed on a content aggregator home screen.

In this embodiment, the user interface of the content aggregator displayed on the television includes a section 710 that is a sponsored section. The user interface also includes sections 715 and 720 that relate to the current weather and a sign-in area. The user interface also may include a strip for recommended media assets. As displayed at block 725, these media assets in one embodiment may be movie 1, music album 1, movie 2, and FIFA Women's World Cup.

In some embodiments, at the bottom of the user interface, a row of icons that are associated with streaming media and streaming audio service providers may be displayed. As depicted, blocks 730, 735, 740, and 745 (i.e., icons for Netflix, Sling, Pandora, and Amazon) represent various icons for various service providers from whom content may be obtained and viewed on the display device. Blocks 730-745 are displayed as still images prior to the icons being activated as active media tiles.

FIG. 7B is a block diagram of a home screen of a user interface with active media tile(s) being displayed, in accordance with some embodiments of the disclosure. In some embodiments, after an icon has been selected for making it into an active media tile, such as at block 103 of FIG. 1, the control circuitry 200 and/or 228, such as the control circuitry that belongs in the operating system of the content aggregator platform, and may be software or hardware, may look for a trigger mechanism to activate the icon and display a content file within the boundaries of the selected icon. The trigger mechanism, in some embodiments, may be hovering of a TV remote control navigation over the icon. In another embodiment, the trigger mechanism may be the launch of the home screen of the content aggregator user interface. Some examples of triggers for icon/tile activation are described in further detail in relation to FIG. 14.

In some embodiments, as depicted in FIG. 7B, the control circuitry 200 and/or 228 may have had selected the Netflix icon for making it into an active media tile. Accordingly, as depicted at block 755, a video file containing people jet skiing on the ocean may be displayed when any of the trigger mechanisms have been activated. For example, the video of the people jet skiing may be displayed when the home screen on the user interface of the content aggregator is displayed. The display of the video may be done without launching the underlying executable application. Some examples of triggers for icon/tile activation are described in further detail in relation to FIG. 14.

In some embodiments, as depicted in FIG. 7B, the control circuitry 200 and/or 228 may rearrange, modify, or remove icons from the home screen of the user interface. As depicted, the control circuitry 200 and/or 228, in this embodiment, has switched the places of Sling and Pandora icons on the user interface 770. The control circuitry 200 and/or 228 in this embodiment has also removed the sponsored section and moved the icon for Amazon into the sponsored section. The control circuitry 200 and/or 228 has also enlarged the icon and displayed it as an active media tile at 750. Also in this embodiment, the control circuitry 200 and/or 228 displays progress bar in the icon 750. The progress bar and the display within the icon for Amazon may relate to a movie that the user has been consuming and has stopped midway without finishing the movie. The progress may indicate the state at which the user last ended the movie and the live display in the tile may be used to entice the user to select the icon to continue watching the movie.

In some embodiments, when an active media tile is activated, the display depicted within the active media tile may be deep-linked to the content that it represents. For example, if an active media tile includes a video montage of five different movies, e.g., Movies 1-5, then, if the user selects the active media tile while Movie 3 is being displayed in the montage, then, since the active media tile is deep-linked, the user may be automatically navigated to Movie 3. In such an instance of user selecting Movie 3, i.e., skipping to the third movie in the montage, the last selected movie, which is Movie 3, is logged in the user's profile as a preferred selection of the user. All the active media tiles, as described in this figure and all the figures in this application, may be deep-linked to the content presented.

FIG. 7C is a block diagram of a home screen of a user interface via an XR device, in accordance with some embodiments of the disclosure. In this embodiment, an XR device 775 is used as a display device. The XR device 775 may be a wearable device, such as smart glasses with control circuitry, that allows the user to see through a transparent glass to view the content aggregator home screen. The XR device may also be a pair of augmented reality glasses that includes video see-through functionality. As depicted, the icon for Netflix 780 has activated a active media tile in this embodiment to display a video within the icon. The display of the video may be done without launching the Netflix application.

FIG. 8 is a block diagram of examples of icon selection options that may be utilized to display an active media tile, in accordance with some embodiments of the disclosure. In some embodiments, as described in block 102 of FIG. 1 and block 510 of FIG. 5, the control circuitry 200 and/or 228 may determine a selection criterion for selecting any one or more icons associated with executable applications. In some instances, using the selection criteria, only one icon may be selected, and in other instances, multiple icons may be selected.

In some embodiments, bidding 810 may be used as a selection criterion. Bids received from a plurality of service providers may be used to select one or more icons such that a content file may be played within the boundaries of the selected icon. FIG. 9 is a flowchart of a process for selecting one or more winners from multiple bids received from service providers, in accordance with some embodiments of the disclosure. Referring to FIG. 9, the process 900 may be implemented, in whole or in part, by systems or devices such as those shown in FIGS. 2-4. One or more actions of the process 900 may be incorporated into or combined with one or more actions of any other process or embodiments described herein. The process 900 may be saved to a memory or storage (e.g., any one of those depicted in FIGS. 2-3) as one or more instructions or routines that may be executed by a corresponding device or system to implement the method 900.

In some embodiments, at block 905, the control circuitry 200 and/or 228 may receive two or more bids from two or more service providers for displaying content within their icons that displayed on the home screen of the user interface. For example, the control circuitry 200 and/or 228 may receive a bid from any of the icons listed in FIG. 1 or 7A, such as from Netflix, Sling, Pandora, Amazon.

As described earlier, the bidding process, in some embodiments, may be used by the control circuitry 200 and/or 228 to determine which icons can be made as active media tiles and which icons to keep as still images. Since bandwidth and other system requirements, such as CPU usage, may constrain the control circuitry 200 and/or 228 from displaying content in all the icons displayed on the home screen of the user interface of the content aggregator, only a selected number of icons may be identified, such as via the bidding process, to play live content within the icon.

In other embodiments, the control circuitry 200 and/or 228 may use the bidding process to generate revenue or to determine which service provider's icon to highlight to its audience. For example, if both Netflix and Amazon Prime are competing for displaying an action movie within their icons, the control circuitry 200 and/or 228 may receive bids from both to select one of the two to display the action movie.

At block 915, the control circuitry 200 and/or 228 may analyze the received bids. The analysis may comprise analyzing a plurality of factors to select a winning bid(s). Some of the factors analyzed may include pricing submitted in the bid, type of content that is to be displayed within the icon, duration of the display, timing of the display (e.g., what time of day), amount of bandwidth and storage space required for the display, CPU utilization for displaying the content, whether the content new or trending, etc. The control circuitry 200 and/or 228 also utilize AI to determine which content would be the best to keep the user engaged and use the AI suggestions as a basis for selecting from among the received bids.

At block 920, the control circuitry 200 and/or 228 may determine whether the content complies with editorial policies. Some examples of the types of editorial policies are described in FIG. 13. The policies may, for example, identify what type of content is acceptable. The policies may provide details as to what genre, content length, and content quality are accepted. The policies may also indicate which time slots are available, such as what times of day, for what type of content. For example, the control circuitry 200 and/or 228 may only reserve one spot for featuring an action movie during the hours of 7-10 PM so as not to inundate their audience with too many action movie choices, and as such may indicate that only one spot for an action movie is available for display in an active media tile.

If a determination is made at block 920 that a bid received (for content to be displayed in an icon) does not satisfy the editorial policy, then the control circuitry 200 and/or 228 may reject the bid, at block 925. Optionally, the control circuitry 200 and/or 228 may inform the bid sender at 930 and receive an updated bid at 935 from the same sender that does comply with the editorial policy. If such an updated bid is received, then the control circuitry 200 and/or 228 may analyze it again at block 920 for compliance with editorial policy.

If a determination is made at block 920 that the bids received (for content to be displayed in an icon) satisfy the editorial policy, then the control circuitry 200 and/or 228, at block 940 may select a winning bid. Depending on the number of simultaneous streams that are determined to be played, the control circuitry 200 and/or 228 may select more than one bid for making the icon into an active media tile and playing content within the icon, based on display options and bid details, as depicted at block 950, without launching the underlying executable application. For example, the control circuitry 200 and/or 228 may select two or three top bids and make icons related to those top bids as active icons/tiles. Accordingly, the control circuitry 200 and/or 228 may play content simultaneously in all the top two or three icons from the manifest files received from service providers associated with those icons without launching the associated underlying executable applications.

The bidding process may also be used by the control circuitry 200 and/or 228 to determine allocate bandwidth to different icons when more than one icon is displayed as an active media tile. For example, the control circuitry 200 and/or 228 may allocate the most bandwidth (i.e., higher bitrate video) to the highest bidder. The control circuitry 200 and/or 228 may also allocate same bandwidth to multiple active media tiles.

The bidding process may also be used by the control circuitry 200 and/or 228 to reorder active media tiles on the home screen. For example, the control circuitry 200 and/or 228 may make the active media tile for the highest bidder more prominent that other active media tiles or may move them highest bidder's active media tile at the start or top of the list of active media tiles.

Referring back to FIG. 8, in some embodiments, a round robin 820 method may be used as a selection criterion. In this embodiment, the control circuitry 200 and/or 228 may take turns switching from one icon to the right next in a round robin fashion to make each icon an active media tile sequentially such that service providers associated with the icons get to present their content in their respective active media tiles.

In another embodiment, the control circuitry 200 and/or 228 may use trending content 830 as a section criterion for determine which icon to make as an active media tile for displaying content within the selection icon without launching the underlying application. In this embodiment, the control circuitry 200 and/or 228 may monitor content across various channels to determine which content is currently trending. Based on the monitoring in analysis, the control circuitry may determine which service provider provides the most trending content and based on that request in manifest file wait the identified trending content. The control circuitry may then play the trending content within the icon associated with the service provider that provides such trending content without launching the underlying application.

In another embodiment, the control circuitry 200 and/or 228 may use new content 840 as a section criterion for determine which icon to make as an active media tile for displaying content within the selection icon without launching the underlying application. In this embodiment, the control circuitry 200 and/or 228 may determine which content from various manifest files provided by the service providers is the most current content. Based on the analysis may then select an icon associated with most current content and play the content within the icon without launching the underlying application.

In another embodiment, the control circuitry 200 and/or 228 may use a random method 850 as a section criterion for determine which icon to make as an active media tile for displaying content within the selection icon without launching the underlying application. In this embodiment, the control circuitry 200 and/or 228 may use a random method, such as a skip from one icon to another based on type of content, type of genre, most current content, or another random method of selection of icons.

In another embodiment, the control circuitry 200 and/or 228 may use user or system generated selection formula 860 as a section criterion for determine which icon to make as an active media tile for displaying content within the selection icon without launching the underlying application. In this embodiment, the control circuitry 200 and/or 228 may use a formula generated by the user or system, such as show only action movies during the evenings and PG 13 content during weekend, or some based on some other formula that may be generated based on user preferences or user consumption history.

In another embodiment, the control circuitry 200 and/or 228 may use the results of a recommendation engine 870 as a section criterion for determine which icon to make as an active media tile for displaying content within the selection icon without launching the underlying application. In this embodiment, the control circuitry 200 and/or 228 may invoke an AI or ML engine to execute an AI or ML algorithm. The control circuitry 200 and/or 228 use the results provided from the algorithms at the aggregator level to select an icon to make as an active media tile. In this embodiment, the aggregator may use automatic content recognition (ACR) to determine what the consumes across all platforms (but not across all devices), so it can infer a preference score based on the various personalized manifests it receives from the various OTT providers and display the active tile that corresponds to the highest score. Although a few methods of icon selection have been described in FIG. 8, the embodiments are not so limited in any other 880 selection method may also be utilized.

FIG. 10 is a block diagram of examples of content types that can be provided by an OTT service provide to the TV OS for selection, in accordance with some embodiments of the disclosure. The content type selection described in FIG. 10 may be selections made by an OTT service provider to provide to the connect TV's operating system (OS). The TV OS may then utilize one or more of the selection criteria as described in FIG. 8 to determine which icon or icons to make as active media tiles.

In some embodiments, the content type may be selected by the OTT service provider based on one or more content type selections described in FIG. 10. In another embodiment, the control circuitry 200 and/or 228 may provide device and user data to a service provider, and the service provider, such as Netflix, may determine the content type and transmit a manifest file that references URLs for the TV OS to access the content referenced and display within the icon without launching the executable application. Since Netflix or another OTT provider may already have the device and user data that relates to user consumption via their own service, i.e., when user watches content on Netflix, the user data provided to the service provider as mentioned in FIG. 10 may relate to user consumption data from consumption from other OT service providers, such as Amazon Prime's consumption data to Netflix if such privacy and sharing rules allow such sharing. In all the embodiments, especially when multiple icons are made into active media tiles, the content aggregator may have visibility of the content being played in each active media tile. It may track such content and keep a list of what content is played in which active media tile. Having such visibility and keep track may allow better management of content being played across multiple active media tiles, such as by not repeating same type of content, same genre of content, etc. in multiple active media tiles.

In some embodiments, an OTT provider may select trending content 1010 to provide to the connect TV OS. Displaying trending content may attract a user of the user interface and keep them engaged. Trending content displayed in an icon may also entice the user to select the icon. The control circuitry may deep link the icon such that once a user selects the icon, then are automatically navigated to the display of the content.

In some embodiments, an OTT service provider may select the type of content based on an AI recommendation 1020. In these embodiments, the OTT service provider may invoke an AI engine to execute an AI algorithm. The OTT service provider may provide user data, such as user consumption patterns, user's last watched movie, and any other user data to obtain the recommendation from the AI engine. Based on the AI recommendation, the OTT service provider may select the type of content and provide it to the connected TV OS.

In some embodiments, OTT service provider may select the type of content based on an ML recommendation 1030. In these embodiments, the OTT service provider may invoke an ML engine to execute an ML algorithm and analyze user consumption history. Based on the ML recommendation, the OTT service provider may transmit content to the connected TV OS.

In some embodiments, OTT service provider may use preferences stored in a user profile 1050 to select the type of content. In these embodiments, the OTT service provider may access the user profile and determine if any preferences are stored. Based on the preferences, the OTT service provider may select the type of content to be send to the connected TV OS for display within the icon without the TV OS launching the underlying executable application.

In some embodiments, the OTT service provider select content type based genre 1060. For example, a determination may be made by the OTT service provider that a particular genre is more attractive to the user. Accordingly, the OTT service provider may send content with a selected genre to the connected TV OS.

In some embodiments, the OTT service provider may select different types of content based on the level of subscription with the OTT service provider. For example, content type selected for a user that is subscribed to a higher tier may be different than content type selected by the OTT service provider for a lower tier subscription. Such selected of content type may then be send to the connected TV OS for display within the icon. In some embodiments, the OTT service provider may display a video that details the subscription levels and pricing as an advertisement or push forward certain sales and deals in the display of their icon when the user is not subscribed to entice them to purchase a subscription.

In some embodiments, the OTT service provider may monitor the user's social media activities 1090 and other electronic messages and communications, such as with friends 1080, to determine the type of content for the user. The OTT service provider may analyze the social media activities 1090 and friend/other recommendations 1080, select content type based on such analysis, and send the content to the connected TV OS for display. When referring to sending the content, it may be a manifest file that references the content that may be sent to the connected TV OS, which allows access to the content, such as via URL's in the manifest file.

Although some examples of selecting a content type by the OTT service provider have been described, the embodiments are not so limited. The OTT service provider may utilize any other recommendations or user activities to determine a content type.

FIG. 11 is a block diagram of examples of display format options that may be used to display or play media content in an active media tile, in accordance with some embodiments of the disclosure.

In some embodiments, the control circuitry 200 and/or 228 may select a video montage 1105 as a display format or display option. The display format selected may then be played in the icon selected without executing the underlying executable application that is correlated with the selected icon. In other embodiments, the control circuitry 200 and/or 228 may receive a video montage from the service provider as the type of display format to play within the icon. The service provider may send the video montage in a manifest file, with or without receiving any data from the control circuitry 200 and/or 228. The video montage may be a compilation of a plurality of shows, movies, audio files, or any other type of content that a service provider compiles. The video montage may be a short segment, such as a five to 30-second segment, that, when played in the icon, plays the compilation.

In some embodiments, the control circuitry 200 and/or 228 may select a trailer 1110 as a display format or display option. The display format selected may then be played in the icon selected without executing the underlying executable application that is correlated with the selected icon. In other embodiments, the control circuitry 200 and/or 228 may receive a trailer 1110 from the service provider as the type of display format to play within the icon. The service provider may send the trailer 1110 in a manifest file, with or without receiving any data from the control circuitry 200 and/or 228. The trailer 1110 may be a trailer of a movie or a show that is accessible by the service provider associated with the selected icon. The control circuitry 200 and/or 228 may also deep link the trailer 1110 such that, if a selection is made of the icon during the playing of the trailer 1110, then the deep-link may be used to automatically navigate the user to the show or movie related to the trailer 1110.

In some embodiments, the control circuitry 200 and/or 228 may select a significant scene 1115 as a display format or display option. The display format selected may then be played in the icon selected without executing the underlying executable application that is correlated with the selected icon. In other embodiments, the control circuitry 200 and/or 228 may receive a significant scene 1115 from the service provider as the type of display format to play within the icon. The service provider may send the significant scene 1115 in a manifest file, with or without receiving any data from the control circuitry 200 and/or 228. The significant scene 1115 may be from a movie or a show that is accessible by the service provider associated with the selected icon. The control circuitry 200 and/or 228 may also deep link the significant scene to where it occurs in the movie or show such that, if a selection is made of the icon during the playing of the significant scene 1115, then the deep-link may be used to automatically navigate the user to the significant scene 1115 in the show or movie.

In some embodiments, the control circuitry 200 and/or 228 may select an audio-only 1120 option to play the related audio within the icon. The audio may also be provided by the service provider in a manifest file, with or without receiving any data from the control circuitry 200 and/or 228. The audio 1120 may be from a music album, a soundtrack of a movie or show, or some other sound bite. The control circuitry 200 and/or 228 may also deep link the audio such that if a selection is made of the icon during the playing of the audio 1120, then the deep-link may be used to automatically navigate the user to the source of the audio.

In some embodiments, the control circuitry 200 and/or 228 may select a video summary 1125 as a display format or display option. The display format selected may then be played in the icon selected without executing the underlying executable application that is correlated with the selected icon. In other embodiments, the control circuitry 200 and/or 228 may receive the video summary 1125 from the service provider as the type of display format to play within the icon. The service provider may send the video summary 1125 in a manifest file, with or without receiving any data from the control circuitry 200 and/or 228. The video summary 1125 may be a summary of a plurality of movies, a single movie, a single show, etc. It may be a video clip, or it may be a textual summary in a video format.

In some embodiments, the control circuitry 200 and/or 228 may select a newly released movie 1130 as the display option. The newly released movie 1130 may then be played in the icon selected without executing the underlying executable application that is correlated with the selected icon. In other embodiments, the control circuitry 200 and/or 228 may receive a segment of a newly released movie 1130, or a trailer of the movie, from the service provider for displaying in the icon. The service provider may send the newly released movie 1130 in a manifest file, with or without receiving any data from the control circuitry 200 and/or 228. The newly released movie 1130 may be deep-linked such that if a selection is made of the icon during the playing of the newly released movie 1130, then the deep link may be used to automatically navigate the user to the newly released movie 1130.

In some embodiments, the control circuitry 200 and/or 228 may select a video of a next episode 1135 following the last episode the user watched as the display option. The video of a next episode 1135 may then be played in the icon selected without executing the underlying executable application that is correlated with the selected icon. In other embodiments, the control circuitry 200 and/or 228 may receive the video of a next episode 1135 from the service provider for displaying in the icon. The service provider may send the video of the next episode 1135 in a manifest file, with or without receiving any data from the control circuitry 200 and/or 228. The video of the next episode 1135 may be deep-linked such that, if a selection is made of the icon during the playing of the video of the next episode 1135, then the deep link may be used to automatically navigate the user to the next episode 1135. In some embodiments, the control circuitry 200 and/or 228, such as via an AI or ML engine inferencing an AI or ML model, may determine the user's consumption history. If the user has consumed a previous episode in a series, then such data may be transmitted to the service provider such that the service provider may sent a customized manifest file that includes the next episode, or some trailer of the next episode, to entice the user to continue consuming the series. In some instances, the previous episode may be from the same provider, and in other instances the previous episode consumed may be from another provider.

In addition to the embodiments described above, the control circuitry 200 and/or 228 may also display viewing progress 1140 of a show or movie or display a song name or song list 1150 in the icon selected without executing the underlying executable application that is correlated with the selected icon. It may also display any other type of display in any of the formats as pushed forth by the service provider.

FIG. 12 is a block diagram of processing options that may be used by a service provider when providing a manifest file for display, in accordance with some embodiments of the disclosure.

In some embodiments, once content is selected by the service provider for transmitting to the control circuitry for display in the icon, the service provider may use appropriate processing technologies for preparing the content (e.g., multimedia showcase) to overlay on or embed within the home screen on the selected icon. These technologies may include transcoding 1210, video scene detection 1220, summarization 1230, and transmitting the content at a lower bitrate 1240.

These processing technologies allow the service provider to prepare the content based on the device on which it is to be displayed. For example, transcoding may be done to the manifest file based on the device data received by the service provider from the control circuitry 200 and/or 228. This would ensure that the manifest file is in a format that can be displayed on the display device based on the device's capabilities.

Video scene detection may be performed to determine if the scene can be displayed on the display device as is or if changes to the scene, such as pixel ratio, downscaling resolution, or another technique may need to be applied for the scene to be displayed on the display device.

Summarization may be performed such that a shorter clip is presented in the manifest file instead of the longer video. Doing so would save memory, bandwidth, and CPU utilization for its display.

In some embodiments, a color video may be converted to black and white to save memory. Embodiments may also include showing some key positions, or segments in color, and others in black and white or other colors that require lesser resolution.

Manifest files may also be transmitted at a lower bitrate as needed. In some embodiments, when videos are streamed and a high number of video decoders are available at the display device, but bandwidth is limited, the control circuitry 200 and/or 228 may reserve higher bitrate videos for service providers that have newer content or based on other editorialization policies described in FIG. 13. These may include saving higher bitrate for content produced within a last X number of days 1310, such as five days, 20 days or some other predetermined number. These may also include saving higher bitrate for trending content 1320, genre specific content 1330, and shorter length videos 1340. With respect to genre-specific videos, the control circuitry 200 and/or 228, based on user interest, may save higher bitrate for those genres that are of interest to the user. Although some editorial policies are described above, the embodiments include any other criterion 1350 used by the control circuitry 200 and/or 228 to generate an editorial policy used for reserving high bitrate for videos that meet the criterion.

FIG. 14 is a block diagram of icon/tile activation or triggers used to display content within an icon, in accordance with some embodiments of the disclosure. In some embodiments, the control circuitry 200 and/or 228 may make an icon active, in other words it may play content within the boundaries of the icon, based on some engagement with the icon or the home screen of the user interface by the user. The control circuitry 200 and/or 228 may thus look for triggers for activating the icon.

In some embodiments, the control circuitry 200 and/or 228 may use the launch of the home screen 1410 as a trigger to activate the display within the selected icon. In these embodiments, the control circuitry 200 and/or 228 may determine whether a home screen of the user interface of the content aggregator has been displayed. For example, the home screen may be displayed at the initial launch of the television, upon the user selecting some mode on the television, or upon the user navigating from a sub screen back to the home screen. When such a trigger is detected, the control circuitry 200 and/or 228 may automatically display the content obtained from the manifest file within the selected icon without launching the related underlying executable application.

In some embodiments, the control circuitry 200 and/or 228 may use hovering over an icon 1420 as a trigger to activate the display within the selected icon. In these embodiments, the control circuitry 200 and/or 228 may determine whether a user is hovering over an icon 1420 with their TV remote control navigation. When such a trigger is detected, the control circuitry 200 and/or 228 may automatically display the content obtained from the manifest file within the selected icon without launching the related underlying executable application.

In some embodiments, the control circuitry 200 and/or 228 may use the any interaction with the home screen 1430 as a trigger to activate the display. In some embodiments, the control circuitry 200 and/or 228 may also activate the icon at every instance when the user returns to the home screen 1440. In other embodiments, the control circuitry 200 and/or 228 may activate the icon not at every instance but once a certain number of instances when the user returns to the home screen 1440, such as for the first instance 1450, or the first three instances when the user navigates from a sub screen to a home screen, or any other predetermined number.

In some embodiments, the control circuitry 200 and/or 228 may use the gaze directed to the home screen 1460 or to a specific icon as a trigger to activate the display within the selected icon. In this embodiment, the control circuitry 200 and/or 228 may monitor the user's gaze using a camera, such as in inward-facing camera in an XR device, to determine whether the user's gaze is directed at the home screen of the user interface or a specific icon. When such a trigger is detected, the control circuitry 200 and/or 228 may automatically display the content obtained from the manifest file within the selected icon without launching the related underlying executable application. For example, if the gaze is directed generally at the home screen, then the control circuitry 200 and/or 228 may automatically activate any one or more of the icons, and if the gaze is directed as a specific icon, the control circuitry 200 and/or 228 may activate the specific icon to which the gaze is directed.

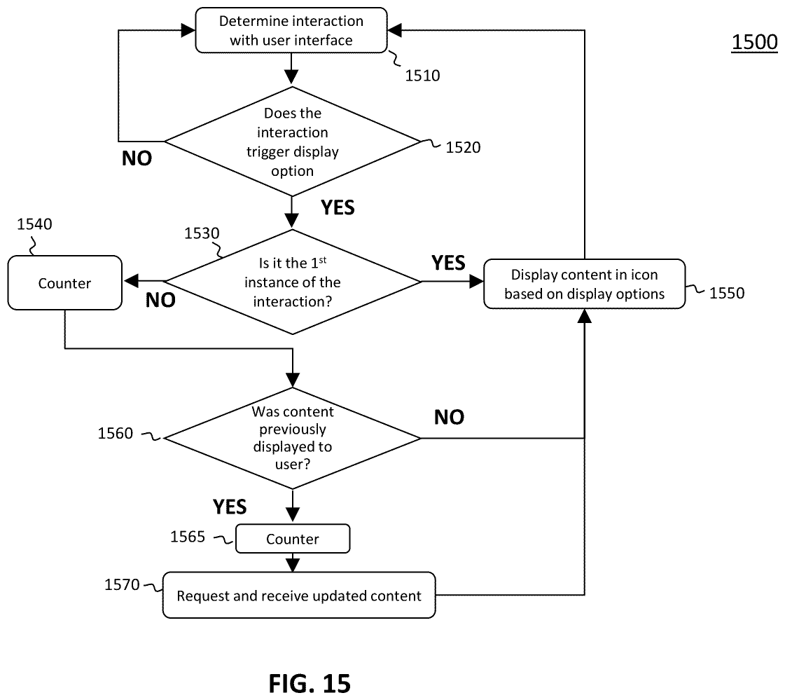

FIG. 15 is a flowchart of a process for updating content for displaying in an icon, in accordance with some embodiments of the disclosure. The process 1500 may be implemented, in whole or in part, by systems or devices such as those shown in FIGS. 2-4. One or more actions of the process 1500 may be incorporated into or combined with one or more actions of any other process or embodiments described herein. The process 1500 may be saved to a memory or storage (e.g., any one of those depicted in FIGS. 2-3) as one or more instructions or routines that may be executed by a corresponding device or system to implement the method 1500.

Process 1500 in some embodiments is used to keep content updated and fresh. If a user navigates to the home screen of a user interface more than once and sees the same content displayed in an icon, and still does not select the icon, the content displayed in the icon is likely not enticing enough for the user to select the icon for launching the underlying application. As such, a determination may be made, by the control circuitry 200 and/or 228, such as based on recommendation from an AI or ML search engine executing an AI or ML algorithm, whether and when to obtain updated content in order to make the content appealing to the user. Process 1500 may be used in this respect, in one embodiment, to determine whether to update the content and if so what content to display that may be appealing.

In some embodiments, at block 1510, the control circuitry 200 and/or 228 may determine an interaction with the user interface of the content aggregator. The interaction may be of any type. For example, the interaction may be a user hovering (such as their finger, computer mouse, or TV remote control navigation) over the home screen of the user interface. Another type of interaction may be that the user has launched the home screen from another sub screen. Yet another interaction may be that the user's gaze is directed towards the home screen of the user interface.

At block 1520, the control circuitry 200 and/or 228 may determine whether the interaction (with the user interface of a specific icon) triggers the display option. Examples of triggering options that may activate the icon are described in FIG. 14. If a determination is made at block 1520 that the interaction does not trigger the display option, then the control circuitry 200 and/or 228 may continue to monitor for interactions with the user interface until it identifies an interaction that does trigger the display option.

If a determination is made at block 1520 that the interaction does trigger the display option, then the control circuitry 200 and/or 228 may determine at block 1530 whether it is the first instance of the interaction with the user interface (or the icon). If a determination is made at block 1530 that it is a first interaction with the user interface (or the icon), then, at block 1550, the content is displayed in the icon. Since the first instance relates to first impression or first view of the content displayed, the content is new and fresh for the user and not mundane or repetitive.

If a determination is at block 1530 that this is not the first interaction with the user interface (or the icon), then, at block 1550, a counter may be used to keep track of the number of instances that the user has interacted with the home screen or icon. The process may continue to determine, at block 1560, whether the content was previously displayed to the user. If a determination is made that content was not previously displayed to the user, which means that the content is fresh and new to the user, then at block 1550, the content is displayed in the icon. If a determination is made that content was previously displayed to the user, which means that the content is not fresh, then, in one embodiment, the control circuitry 200 and/or 228 may transmit a request to the service provider to provide updated content. Upon receipt of the updated content, the control circuitry 200 and/or 228 may at block 1550, display the content in the icon. In other embodiments, the control circuitry 200 and/or 228 may analyze the count kept by the counter 1565 to determine how many times the same content was displayed to the user. In some embodiments, the control circuitry 200 and/or 228 may continue to play the content even if it was previously played, but only for a smaller number of times, such as two or three times or some other predetermined number of times. In that scenario, the control circuitry 200 and/or 228 may continue playing the content until a threshold number of repetitions of the same content is determined. In other embodiments, the control circuitry 200 and/or 228 may at block 1570, request updated content if previously played or if the number of repetitions of content exceeds the threshold.

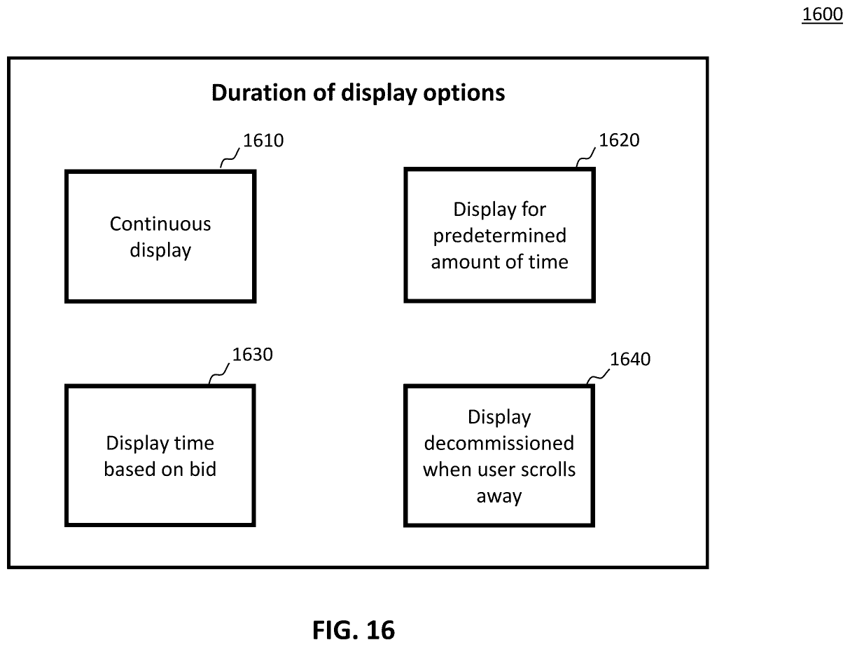

FIG. 16 is a block diagram of display duration options for displaying content within an icon, in accordance with some embodiments of the disclosure. The duration of the display within the icon may be defined by the control circuitry or by the service provider. In some embodiments, the display within the icon may be a continuous display 1610.

In other embodiments, the display within the icon may be a display for a predetermined amount of time 1620. For example, the display may be for 5, 1, 15 seconds or some other predetermined amount of time. The display may loop and repeat after the predetermined amount of time has expired or be changed to a still image.

In some embodiments, the duration of the display within the icon may be based on the bid 1630 provided by the service provider and approved by the display device or its control circuitry. For example, if Netflix places a bid to make its icon active and, in the bid, specifies that the content to be played is for 12 seconds, and the bid is accepted, then the duration would be for 12 seconds.

In some embodiments, the display within the icon may be decommissioned when the user scrolls away. It may also be decommissioned if a determination is made that the user's gaze is directed elsewhere and not on the user interface of the content aggregator or the icon. This implementation may depend primarily on the system capability of being able to initialize (and run) multiple video players, one embedded within each icon of a plurality of icons. If the system has limited resources and memory, it may decommission a video player when a user scrolls away from an icon (or gazes away) and initialize a video player in another icon to which the user has navigated. On the other hand, the system may be capable enough of running multiple video players at the same time. In this case, the system may play multiple videos, one within the boundary of each icon. It may, however, play audio only for the icon that the user has currently navigated to. In yet another embodiment, the control circuitry may pause the video in an icon, when the user scrolls away, even if the video player remains active. The pause may gradually transition to the original logo or the static image in the icon, such as to indicate which service provider is associated with the icon (e.g., Netflix logo). The video may resume if the user hovers over the icon again. Lightweight video player technologies such as VLC may be encapsulated inside each icon.

FIG. 17 is a block diagram of video montage containing videos from different media assets, in accordance with some embodiments of the disclosure. In some embodiments, each segment or portion of the montage, where each segment or portion relates to a different media asset, may be deep linked. When the montage is displayed within an icon, selection of the icon may directly transport the user, based on the deep-linking, to the portion that was currently playing at the time of the selection. For example, a 10-second video montage 1700, as displayed in FIG. 17, may include a montage of four different media assets, 1710, 1720, 1730, and 1740. The four media assets, which, combined together, make the montage, may each be deep linked to the media asset they represent. If a user selected the icon during the playing of the montage, such as at the five-second mark, at which point the portion of the display 1730 may relate to a media asset of jet skis, then the user may be automatically transported to the media asset associated with the display 1730. As depicted in further detail in FIG. 18, each such media asset, of the four media assets, may have separate deep links. For example, a media asset that is represented by portion/segment 1710 in the video montage may be associated with Deep link 1, which if selected would automatically transport the user to the media asset associated with the portion/segment 1710. Likewise, a media asset that is represented by portion/segment 1720 in the video montage may be associated with Deep link 2, which if selected would automatically transport the user to the media asset associated with the portion/segment 1720, and so on. In some embodiments, the deep link may be generally to the start of the media asset and in other instances the deep link may be to the exact scene in the media asset that is displayed in the montage.

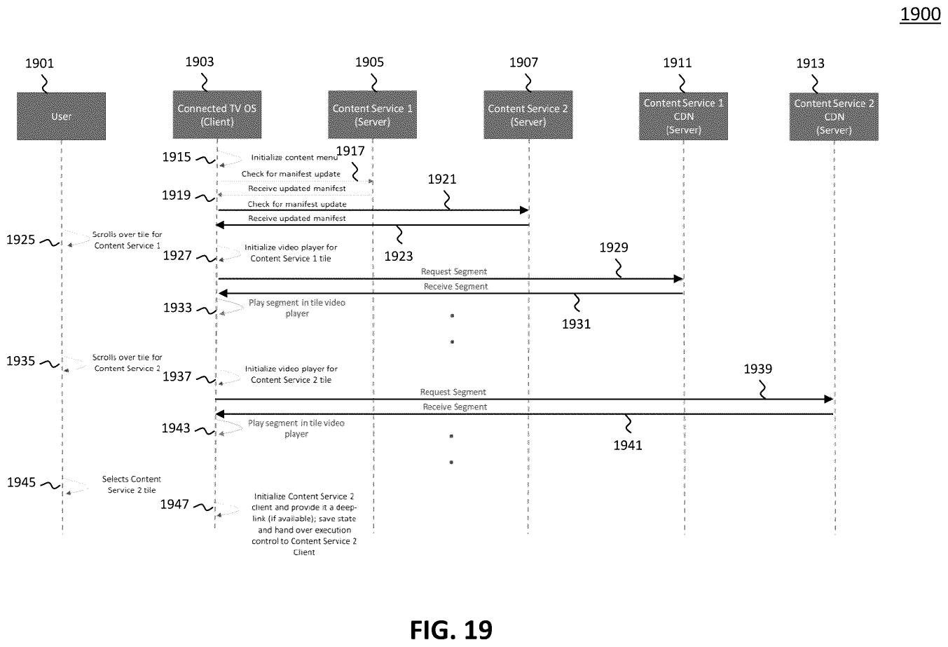

FIG. 19 is a flowchart of a communication process between a plurality of devices for displaying or playing media content within an icon associated with an executable application, in accordance with some embodiments of the disclosure. The process 1900 may be implemented, in whole or in part, by systems or devices such as those shown in FIGS. 2-4. One or more actions of the process 1900 may be incorporated into or combined with one or more actions of any other process or embodiments described herein. The process 1900 may be saved to a memory or storage (e.g., any one of those depicted in FIGS. 2-3) as one or more instructions or routines that may be executed by a corresponding device or system to implement the method 1900.

In some embodiments, the device in process 1900 includes a connected TV OS 1903, content service 1 1905, content service 2 1907, content service 1 CDN 1911, and content service 2 CDN 1913. A user is also part of the process and communicates by engaging with the icons or the home screen of the user interface.

In some embodiments, at 1915, connected TV OS 1903 initiates a content menu. Then the connected TV OS 1903, at 1917, checks for a manifest update from a plurality of content service providers such as content service 1 1905, content service 2 1907, content service 1 CDN 1911, and content service 2 CDN 1913. In response to checking for a manifest file, the OS receives an updated manifest file from the content services.

In some embodiments, the user engagement with the user interface of the content aggregator and engagement with the tile or icon are monitored. When the user scrolls over the icon or tile, then the connected TV OS initializes the video player for that specific icon and plays the video segment that is received in the updated manifest file from the content service.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
displaying a plurality of icons on a home screen of a user interface of a media device, wherein each icon is associated with an executable application for accessing content from a streaming service provider;
selecting, without user intervention, an icon of at least one executable application, from the plurality of icons displayed on the home screen;
selecting a content item for displaying within a boundary of the selected icon associated with the executable application, wherein the selection of the content item is based on a selection criterion; and
automatically displaying the selected content item within the boundary of the selected icon without launching the executable application associated with the selected icon.

2. The method of claim 1, further comprising:
receiving a manifest file that contains a URL linked to the content item from the streaming service provider corresponding with the selected icon of the executable application; and
storing the received manifest file that includes data linking to the content item in memory of the media device.

3. The method of claim 1, wherein the automatically displaying of the selected content item within the boundary of the selected icon occurs upon displaying of the home screen on the user interface or a content aggregator.

4. The method of claim 1, wherein the selection of the icon of the at least one executable application is based on bidding.

5. The method of claim 4, further comprising:
receiving a bid from each streaming service provider associated with a first and a second executable applications, from the plurality of executable applications;
determining that the bid from the streaming service provider associated with the first executable application is higher in price than the bid from the streaming service provider associated with the second executable application; and
in response to determining that the bid from the streaming service provider associated with the first executable application is higher in price than the bid from the streaming service provider associated with the second executable application, selecting, without user intervention, an icon for the first executable application for automatically displaying the determined content item within the icon of the first executable application.

6. The method of claim 1, wherein the selection criterion for selecting the content item is user consumption history.

7. The method of claim 1, further comprising:
identifying information relating to media device type and user parameters;
transmitting the information relating to the media device type and user parameters to the streaming service provider; and
requesting an updated file that is personalized to the user based on the media device and user parameters transmitted.

8. The method of claim 7, further comprising:
receiving the updated manifest file that is personalized for the user;
determining whether the updated manifest file complies with an editorial policy of the media device; and
in response to determining that the updated manifest file complies with the editorial policy of the media device, displaying content from the updated manifest file within the boundary of the selected icon without launching the executable application associated with the selected icon.

9. The method of claim 1, further comprising:
determining a number of times the selected content item has been displayed on the media device;
determining whether the number of times the selected content item has been displayed on the media device exceeds a predetermined threshold; and
in response to determining that the number of times the selected content item has been displayed on the media device exceeds the predetermined threshold, requesting an updated manifest file from the streaming service provider.

10. The method of claim 1, wherein the selected content item is a video montage, wherein the video montage is a compilation of a plurality of segments from a plurality of media assets that are provided by the streaming service provider.

11. The method of claim 10, further comprising:
deep-linking each segment, from the plurality of segments, of the compilation with its related media asset;
receiving a user selection of the icon in which the video montage is played;
determining that a first segment, from the plurality of segments, associated with a first media asset, from the plurality of media assets, is being played from the montage when the user selection is received; and
in response to the receiving of the user selection during the displaying of the first segment, automatically displaying the first media asset on the media device.

12. A system comprising:
communications circuitry configured to access a media device; and
control circuitry configured to:
display a plurality of icons on a home screen of a user interface of the media device, wherein each icon is associated with an executable application for accessing content from a streaming service provider;
select, without user intervention, an icon of at least one executable application, from the plurality of icons displayed on the home screen;
select a content item for displaying within a boundary of the selected icon associated with the executable application, wherein the selection of the content item is based on a selection criterion; and
automatically display the selected content item within the boundary of the selected icon without launching the executable application associated with the selected icon.

13. The system of claim 12, further comprising, the control circuitry configured to:
receive a manifest file that contains a URL linked to the content item from the streaming service provider corresponding with the selected icon of the executable application; and
store the received manifest file that includes data linking to the content item in memory of the media device.

14. The system of claim 12, wherein the automatically displaying of the selected content item within the boundary of the selected icon occurs upon the control circuitry displaying the home screen on the user interface or a content aggregator.

15. The system of claim 12, wherein the selection of the icon by the control circuitry of the at least one executable application is based on bidding.

16. The system of claim 15, further comprising, the control circuitry configured to:
receive a bid from each streaming service provider associated with a first and a second executable applications, from the plurality of executable applications;
determine that the bid from the streaming service provider associated with the first executable application is higher in price than the bid from the streaming service provider associated with the second executable application; and
in response to determining that the bid from the streaming service provider associated with the first executable application is higher in price than the bid from the streaming service provider associated with the second executable application, select, without user intervention, an icon for the first executable application for automatically displaying the determined content item within the icon of the first executable application.

17. The system of claim 12, further comprising the control circuitry configured to:
identify information relating to media device type and user parameters;
transmit the information relating to the media device type and user parameters to the streaming service provider; and
request an updated file that is personalized to the user based on the media device and user parameters transmitted.

18. The system of claim 17, further comprising, the control circuitry configured to:
receive the updated manifest file that is personalized for the user;
determine whether the updated manifest file complies with an editorial policy of the media device; and
in response to determining that the updated manifest file complies with the editorial policy of the media device, display content from the updated manifest file within the boundary of the selected icon without launching the executable application associated with the selected icon.

19. The system of claim 12, further comprising, the control circuitry configured to:
determine a number of times the selected content item has been displayed on the media device;
determine whether the number of times the selected content item has been displayed on the media device exceeds a predetermined threshold; and
in response to determining that the number of times the selected content item has been displayed on the media device exceeds the predetermined threshold, request an updated manifest file from the streaming service provider.

20. The system of claim 12, wherein the content item selected by the control circuitry is a video montage, wherein the video montage is a compilation of a plurality of segments from a plurality of media assets that are provided by the streaming service provider.
